(19) United States
(12) Patent Application Publication
(10) Pub. No.: US 2009/0223628 A1
(43) Pub. Date: Sep. 10, 2009

(54) MANUFACTURING APPARATUS OF COMPOSITE SUBSTRATE AND MANUFACTURING METHOD OF COMPOSITE SUBSTRATE WITH USE OF THE MANUFACTURING APPARATUS

(75) Inventors: Hideto OHNUMA, Atsugi (JP); Tomoaki MORIWAKA, Isehara (JP)

Correspondence Address: ERIC ROBINSON, PMB 955, 21010 SOUTHBANK ST., POTOMAC FALLS, VA, 20165, US

(73) Assignee: SEMICONDUCTOR ENERGY LABORATORY CO., LTD., Atsugi-shi (JP)

(21) Appl. No.: 12/366,728

(22) Filed: Feb. 6, 2009

(30) Foreign Application Priority Data
Mar. 7, 2008 (JP) 2008-058222

(51) Int. Cl. B32B 37/00

(52) U.S. Cl. 156/288; 156/391; 156/380.9; 156/389

(57) ABSTRACT

A method for bonding a plurality of single crystal semiconductor substrates to a large supporting substrate such as a glass substrate while effectively aligning the substrates, and a method for reducing contaminants attached to a bonding surface during the bonding process. A plurality of single crystal semiconductor substrates are arranged on corresponding trays so that the front surfaces of the substrates face vertically downward, and a large supporting substrate is arranged so that the front surface thereof faces vertically upward. Next, the single crystal semiconductor substrates are spaced from the trays, and pressure is applied to part of each of the single crystal semiconductor substrates while the edges thereof are supported, whereby the front surfaces of the single crystal semiconductor substrates are bonded to the front surface of the large supporting substrate.

### BACKGROUND OF THE INVENTION

1. Field of the Invention

The present invention relates to a manufacturing apparatus of a composite substrate, a manufacturing method of a composite substrate such as an SOI (silicon on insulator) substrate with the use of the manufacturing apparatus, and a manufacturing method of a semiconductor device using the SOI substrate.

2. Description of the Related Art

In recent years, integrated circuits using an SOI (silicon on insulator) substrate where a thin single crystal semiconductor film is formed on an insulating surface have been developed instead of those using a bulk silicon wafer. Since the parasitic capacitance between a drain of a transistor and a substrate is reduced by using an SOI substrate, SOI substrates have attracted attention as substrates to improve the performance of semiconductor integrated circuits.

One of the known methods for manufacturing an SOI substrate is Smart Cut (registered trademark). An outline of the method for manufacturing an SOI substrate by Smart Cut (registered trademark) is described below. First, hydrogen ions are implanted into a silicon wafer by an ion implantation method so that an ion implantation layer is formed at a predetermined depth from a surface. Then, the silicon wafer into which hydrogen ions have been implanted is bonded (attached or joined) to another silicon wafer with a silicon oxide film interposed therebetween. After that, heat treatment is performed so that the silicon wafer into which hydrogen ions have been implanted is separated using the ion implantation layer as a cleavage plane. Thus, a single crystal silicon film can be obtained over the silicon wafer serving as a base substrate. Smart Cut (registered trademark) is also referred to as a hydrogen ion implantation separation method.

A method has also been proposed in which a single crystal silicon film is formed over a base substrate made of glass by such Smart Cut (registered trademark) (for example, see Patent Document 1: Japanese Published Patent Application No. H11-163363). Furthermore, a technique for making small pieces of single crystal silicon into a tiled pattern over a glass substrate has been recently disclosed as a manufacturing method of an SOI substrate for an active matrix liquid crystal display (see Patent Document 2: Japanese Translation of PCT International Application No. 2005-539259).

### SUMMARY OF THE INVENTION

Glass substrates can have a larger area and are less expensive than silicon wafers, and thus are mainly used for manufacturing liquid crystal display devices and the like. By using a glass substrate as a base substrate, a large, inexpensive SOI substrate can be manufactured. In general, a silicon ingot or a silicon wafer that is to be a base material for forming a single crystal silicon layer is small in size compared to a glass substrate. Accordingly, in the case of using a large glass substrate as a base substrate, a plurality of silicon wafers are preferably bonded to the large glass substrate, which is effective in reducing costs.

During the aforementioned process of forming single crystal silicon films over the base substrate, if a plurality of silicon wafers are grasped (e.g., adsorbed) by vacuum when being arranged in a tiled pattern over the large base substrate, contact portions of the semiconductor substrates are changed in shape under load, which causes difficulty in bonding. On the other hand, when the substrates are released from its grasp just before bonding, the semiconductor substrates move on the base substrate with an air layer generated therebetween, which causes difficulty in relative alignment. In addition, when the base substrate and the semiconductor substrates are separated from each other after bonding, the semiconductor substrates move on the base substrate and the surface of the base substrate is damaged.

Furthermore, in order to bond a plurality of semiconductor substrates to a base substrate, it is necessary to perform bonding as many times as the number of silicon wafers. With an increase in the number of bonding operations, mechanical operations for grasping and transferring the silicon wafers are increased, leading to an increase in the amount of dust. Contaminants present on a bonding surface during treatment for bonding different substrates cause a defect in which a separated SOI substrate cannot be obtained.

In view of the foregoing problems, an object of the present invention is to provide a manufacturing apparatus of a composite substrate, which is capable of bonding a plurality of first substrates to a second substrate with effective alignment.

Another object of the present invention is to propose a method for bonding a plurality of first substrates to a second substrate while effectively aligning the substrates. Still another object of the present invention is to propose a method for reducing contaminants attached to a bonding surface during the bonding process. A further object of the present invention is to propose a method for reducing damage on a surface of a base substrate when a semiconductor substrate is separated from the base substrate after the bonding.

A manufacturing apparatus of a composite substrate, which is an aspect of the present invention, is capable of bonding a plurality of first substrates to a second substrate and has the following features. The manufacturing apparatus includes: a tray for holding and fixing the back surface of each of the first substrates; a first stage having a plurality of the trays, which holds the trays so that surfaces thereof holding and fixing the first substrates face vertically downward and supports the edges of the first substrates; a second stage opposite to the first stage, which holds and fixes the second substrate so that the front surface thereof faces vertically upward; a stage driving portion for moving the first stage and the second stage so that the first substrates and the second substrate are brought close to each other; and a pressure-applying mechanism for applying pressure to part of the back surface of each of the first substrates while the first substrates and the second substrate are close to each other. Note that the first substrates are semiconductor substrates that are preferably silicon wafers or the like, and the second substrate is a base substrate that is preferably a glass substrate or the like.

A manufacturing method of a composite substrate of the present invention has the following features. First, a plurality of first substrates are arranged on corresponding trays so that the front surfaces of the first substrates face vertically downward, and a second substrate is arranged on a second stage so that the front surface of the second substrate faces vertically upward. Next, the first substrates are spaced from the trays, and pressure is applied to part of each first substrate while the edges of the first substrates are supported, whereby the front surfaces of the first substrates are bonded to the front surface of the second substrate. Then, heat treatment is performed on the first substrates and the second substrate.

The plurality of first substrates are arranged over the second substrate. That is, each of the first substrates has a smaller area than the second substrate.

The aforementioned manufacturing method of a composite substrate has a characteristic in that the plurality of first substrates are arranged so that the front surfaces thereof face downward before the second substrate is arranged so that the front surface thereof faces upward. Accordingly, dust from a driving portion in the manufacturing apparatus when the plurality of first substrates are arranged so that the front surfaces thereof face downward can be prevented from being attached to the front surface of the second substrate.

In addition, the aforementioned manufacturing method of a composite substrate has a characteristic in that the edges of the first substrates are mechanically supported by the first stage. Accordingly, the plurality of first substrates can be bonded to a desired portion on the second substrate.

The manufacturing apparatus of a composite substrate of the present invention is preferably provided with a cleaning means to remove contaminants attached to the front surfaces of the first substrates and the front surface of the second substrate before the bonding of the substrates.

The first substrates and the second substrate that are processed by the manufacturing apparatus of a composite substrate of the present invention have a characteristic in that the area of each of the first substrates is smaller than that of the second substrate. When the front surface of each of the first substrates is brought into close contact with the front surface of the second substrate and then first heat treatment is performed, the first substrates are fixed on the second substrate. Similarly, by performing second heat treatment, part of each first substrate is formed over the second substrate and the first substrates are separated from the second substrate. Note that the first heat treatment and the second heat treatment each can be added to the aspect of the structure of the present invention in which the first substrates are brought into close contact with the second substrate.

In the present invention, “upward” refers to “vertically upward” and “downward” refers to “vertically downward”. Note that, if the first substrates or the second substrate do not move from the predetermined position, the present invention can be implemented even when the substrates are tilted from the vertical direction.

In addition, in the manufacturing method of a composite substrate of the present invention, after heat treatment is performed on the first substrates and the second substrate, heat treatment may be performed while the edges of the first substrates are supported, whereby the first substrates may be separated from the second substrate while being supported by the trays. By thus performing the heat treatment while supporting the first substrates and the second substrate, it is possible to prevent the first substrates from moving on the second substrate when the first substrates are separated from the second substrate.

The manufacturing apparatus of a composite substrate in accordance with an aspect of the present invention has a structure in which the edges of the first substrates are mechanically supported when the first substrates are bonded to the second substrate. Accordingly, alignment accuracy in bonding the first substrates to the second substrate is improved, and the first substrates can be bonded to the second substrate with high alignment accuracy.

In the manufacturing method of a composite substrate in accordance with an aspect of the present invention, the plurality of first substrates are arranged when being bonded to the second substrate. Then, the first substrates are transferred so that the front surfaces thereof face downward. Accordingly, the amount of contaminants attached to the front surface of the second substrate can be reduced, resulting in a reduction in contaminants on the bonding surfaces. In the manufacturing method of a composite substrate of the present invention, the first substrates are supported when being separated from the second substrate by heat treatment. Accordingly, the first substrates can be prevented from moving when being separated, and thus damage on the front surface of the second substrate can be reduced.

### BRIEF DESCRIPTION OF THE DRAWINGS

In the accompanying drawings:

FIG. 1 is a diagram illustrating an example of a manufacturing apparatus of a composite substrate;

FIG. 2 is a diagram illustrating an example of a manufacturing apparatus of a composite substrate;

FIG. 3 is a diagram illustrating an example of a manufacturing apparatus of a composite substrate;

FIGS. 4A to 4C are diagrams illustrating an example of a manufacturing apparatus of a composite substrate;

FIG. 5 is a diagram illustrating an example of a manufacturing apparatus of a composite substrate;

FIGS. 6A to 6D are diagrams illustrating an example of a manufacturing apparatus of a composite substrate;

FIGS. 7A to 7D are diagrams illustrating an example of a manufacturing method of an SOI substrate;

FIG. 8 is a diagram illustrating an example of a semiconductor device using an SOI substrate;

FIG. 9 is a diagram illustrating an example of a semiconductor device using an SOI substrate;

FIGS. 10A and 10B are diagrams illustrating an example of a display device using an SOI substrate;

FIGS. 11A and 11B are diagrams illustrating an example of a display device using an SOI substrate;

FIGS. 12A to 12D are diagrams illustrating an example of a manufacturing method of a semiconductor device using an SOI substrate;

FIGS. 13A to 13C are diagrams illustrating an example of a manufacturing method of a semiconductor device using an SOI substrate;

FIGS. 14A to 14C are views illustrating an electronic device using an SOI substrate;

FIGS. 15A to 15D are diagrams illustrating an example of a manufacturing method of an SOI substrate;

FIGS. 16A to 16C are diagrams illustrating an example of a manufacturing method of an SOI substrate; and

FIGS. 17A to 17D are diagrams illustrating an example of a manufacturing method of an SOI substrate.

### DETAILED DESCRIPTION OF THE INVENTION

Embodiments of the present invention will be described below with reference to the drawings. Note that the present invention is not limited to the description given below, and modes and details can be modified in various ways without departing from the spirit and scope of the present invention. Accordingly, the present invention should not be construed as being limited to the description of the embodiments given below. Note that in all the drawings for explaining the embodiments, the identical portions or portions having a similar function are denoted by the identical reference numerals, and description thereof is omitted.

### Embodiment 1

In this embodiment, a structure of a manufacturing apparatus of a composite substrate will be described with reference to drawings.

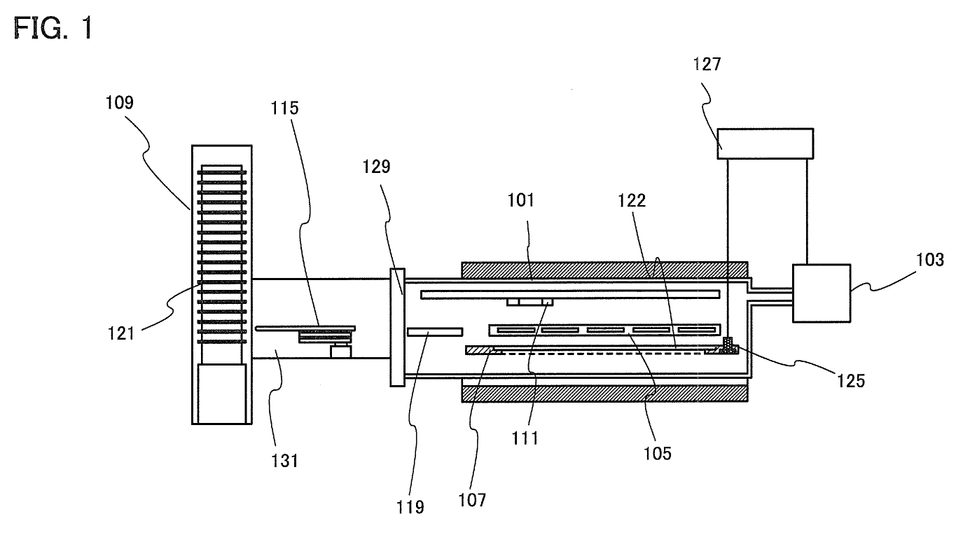

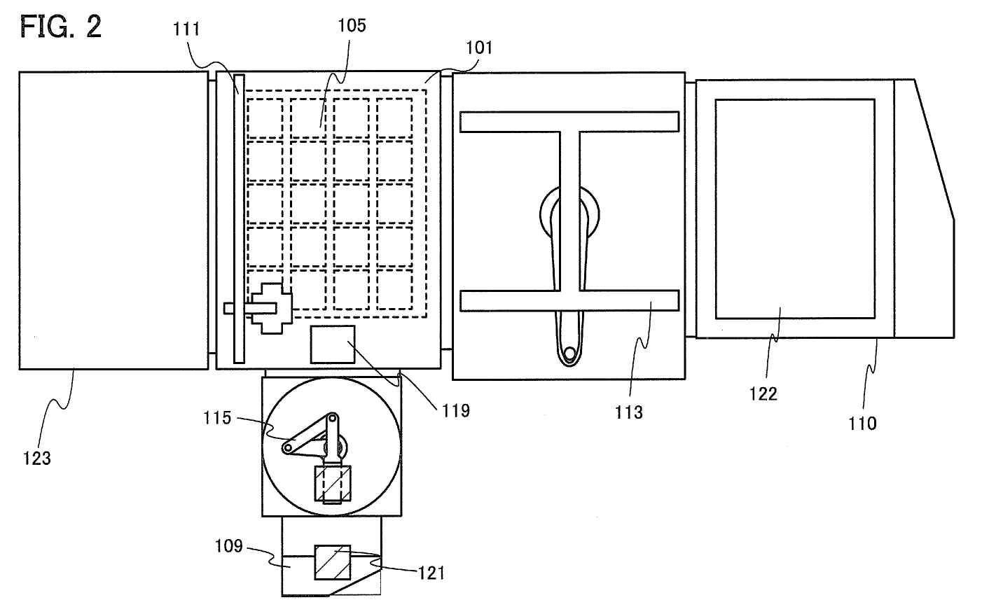

The manufacturing apparatus of a composite substrate illustrated in FIG. 1 and FIG. 2 includes a bonding chamber 101, a heat treatment means such as a heating gas supply unit 103, a first stage 105, a second stage 107, a first cassette chamber 109, a second cassette chamber 110, a first transfer means 111, a second transfer means 113, and a third transfer means 115.

In the bonding chamber 101, a first substrate 121 is bonded to a second substrate 122.

By the heat treatment means, heat treatment can be performed on the second substrate 122 and the first substrate 121 bonded to the second substrate 122. FIG. 1 illustrates an example in which the heating gas supply unit 103 is provided as the heat treatment means in the bonding chamber 101. In that case, it is preferable that the bonding chamber 101 have an inner wall made of quartz or the like and gas such as nitrogen, oxygen, or a rare gas be supplied from the heating gas supply unit 103 at a desired temperature. The heating gas supply unit 103 is controlled by a temperature sensor 125 provided in the second stage 107 and a temperature control unit 127. The substrates that have been subjected to the heat treatment can also be cooled with the gas. Such a structure that heat treatment is performed using the heating gas makes it possible to heat the substrate at a uniform temperature. Heating with the heat treatment means may be performed using the aforementioned high-temperature gas or lamp light. In the case of using a lamp light source, it is preferable that a reflector be additionally provided so that the substrates to be processed are efficiently irradiated with light. As the lamp light source, for example, a rod-shaped halogen lamp can be used. Alternatively, heating may be performed with radiation from an element heated with Joule heat, such as a heater line, and a wide variety of means using thermal conduction heating, convection heating, or radiation heating can be used. With such a heat treatment means, first heat treatment can be performed right after bonding to strengthen the bonding.

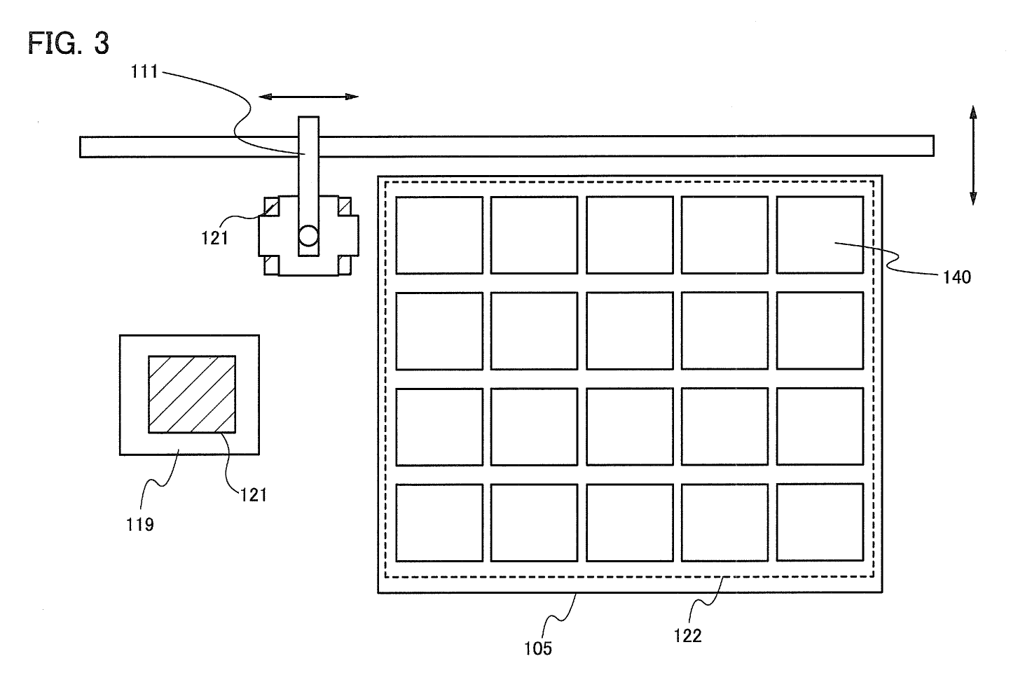

The first stage 105 supports the first substrate 121 and can fix the first substrate 121 with the front surface facing downward. As a fixing method, a tray 140 is provided, onto which the first substrate 121 can be adsorbed by vacuum or static electricity. FIG. 3 illustrates the position in which the second substrate 122 has been transferred to the second stage 107. In addition, FIG. 3 illustrates the state in which the first stage 105 includes as many trays 140 as the number of first substrates 121 bonded to one second substrate 122. The position of each tray 140 of the first stage 105 corresponds to the position of the first substrate 121 bonded to the second substrate 122. Furthermore, the first stage 105 is provided with a pressure-applying mechanism that can apply pressure to part of the first substrate 121. The first stage 105 also includes a mechanism for mechanically supporting the edge of the first substrate 121 when the first stage 105 is brought close to the second stage 107.

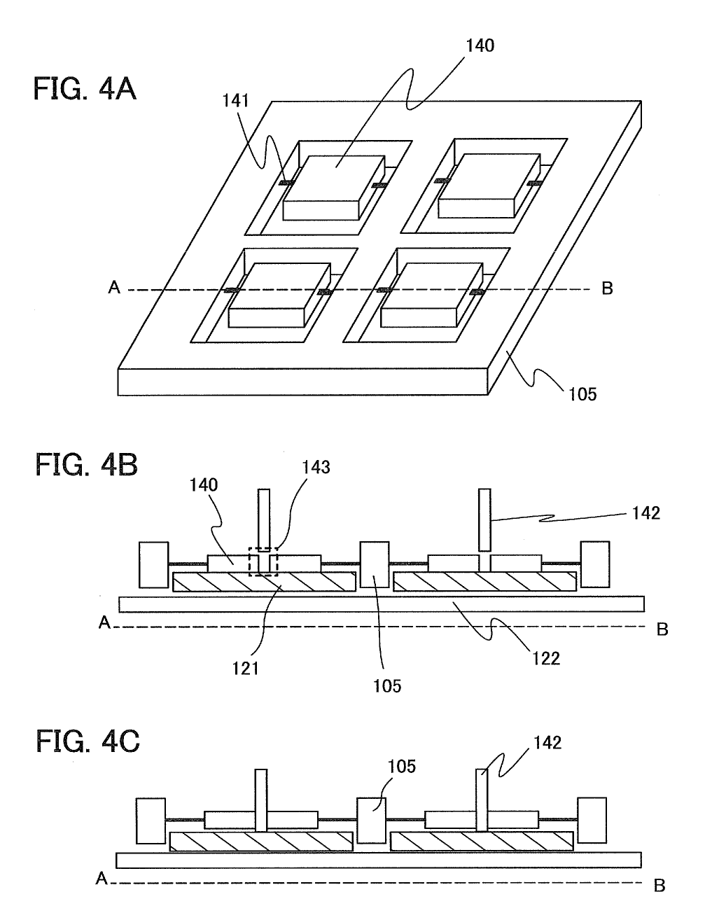

An example of the structure of the first stage 105 is illustrated in FIGS. 4A to 4C. The structure of the first stage 105 illustrated in the drawings is such that the first substrate 121 is received in the tray 140 while the front surface thereof faces upward, and then the front surface of the first substrate 121 is turned downward by a rotating mechanism 141. FIG. 4B is a cross-sectional view taken along line A-B of FIG. 4A and illustrates a structure in which each tray 140 includes an opening 143 that is a space where a pin 142 as a pressure-applying mechanism operates to bond the first substrate 121 to the second substrate 122. When the pressure-applying mechanism operates in FIG. 4B, the first substrate 121 is released from adsorption of the tray 140; however, since the edge of the first substrate 121 is surrounded by the edge of the first stage 105, the first substrate 121 can be prevented from moving as illustrated in FIG. 4C.

The second stage 107 supports the second substrate 122 and can fix the second substrate 122 with the front surface facing upward. As a fixing method, vacuum adsorption or electrostatic adsorption can be used. In addition, although not illustrated, a stage driving portion is provided to move one or both of the first stage and the second stage, whereby the first substrate and the second substrate can be brought close to each other.

The first substrate 121 is stored in the first cassette chamber 109, and the second substrate 122 is stored in the second cassette chamber 110. The second substrate 122 is stored in the second cassette chamber 110 with the front surface facing upward.

The first transfer means 111 transfers the first substrate 121 from a delivery stage 119 to the tray 140 of the first stage 105.

The second transfer means 113 transfers the second substrate 122 to a predetermined position on the second stage 107.

The third transfer means 115 transfers the first substrate 121 from the first cassette chamber 109 to the delivery stage 119.

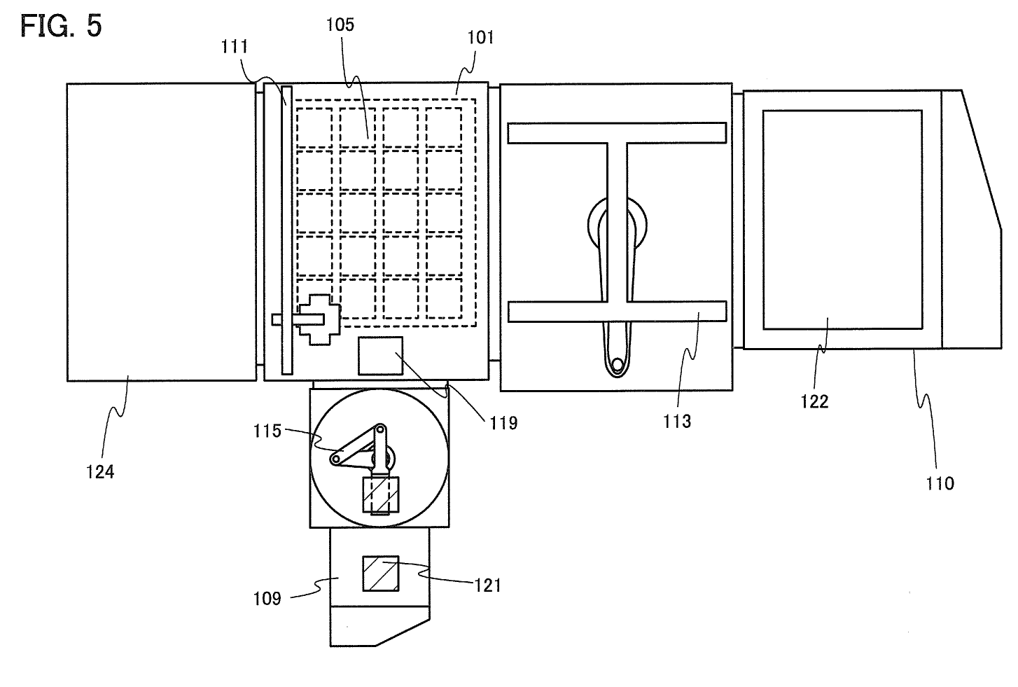

In the case where the heating gas supply unit 103 as the heat treatment means is provided in the bonding chamber 101 as illustrated in FIG. 1 and FIG. 2, it is preferably connected to the bonding chamber 101. If the first stage 105 has low heat resistance, when the substrate is subjected to heat treatment using the heat treatment means in the bonding chamber 101, the first stage 105 can be moved in parallel to be stored in a stage storage chamber 123. Alternatively, as illustrated in FIG. 5, a heat treatment chamber 124 including a heat treatment means may be connected to the bonding chamber 101. In that case, the second substrate 122 and the first substrate 121 bonded to the second substrate 122 are placed on the second stage 107 and transferred to the heat treatment chamber 124 to be subjected to heat treatment.

Although not illustrated, a substrate cleaning means is preferably connected to the manufacturing apparatus of a composite substrate. As the cleaning means, it is possible to use a unit for performing ozone treatment (e.g., ozone water cleaning) or ultrasonic cleaning. In that case, one or both of the ozone treatment and the ultrasonic cleaning may be performed. Alternatively, ozone water cleaning and hydrofluoric acid cleaning may be performed more than once. Further alternatively, as a cleaning mechanism, it is possible to use a cleaning apparatus having a roll brush (made of PVA) that rotates around an axis line parallel to a substrate surface and touches the substrate surface, or a cleaning apparatus having a disk brush (made of PVA) that rotates around an axis line perpendicular to a substrate surface and touches the substrate surface. It is also effective to spray dry ice on a substrate surface to clean the substrate surface. Since dry ice is sublimated (evaporated) to be diffused into the air, the substrate surface can be prevented from being damaged. Furthermore, it is effective to spray gas on a substrate surface to scatter contaminants away from the substrate surface. As a cleaning means, one or both of a mechanism for cleaning the surface of the first substrate and a mechanism for cleaning the surface of the second substrate may be provided. By providing such a cleaning means, before the first substrate and the second substrate are bonded to each other, contaminants attached to the surfaces thereof can be removed more effectively.

The apparatus of the present invention is not limited to the structures illustrated in FIG. 1 and FIG. 2, as long as the apparatus includes as least the bonding chamber 101, the heat treatment means, the first stage 105, and the second stage 107, each of which has the function described in this embodiment. For example, if the apparatus has a structure in which the first substrate is directly transferred from the first cassette chamber 109 to the first stage 105 by the first transfer means 111, the third transfer means 115 and a transfer chamber 131 including the third transfer means 115 do not need to be provided.

A process of bonding the first substrate 121 to the second substrate 122 by the first heat treatment with the use of the apparatus illustrated in FIG. 1 and FIG. 2 will be described below. Note that in this embodiment, description is made on the assumption that the first substrate 121 is a silicon wafer with 126 mm square, which is a kind of semiconductor substrate, and the second substrate 122 is a glass substrate of 600 mm×720 mm, which is one kind of base substrate. In this embodiment, the number of first substrates 121 bonded to the front surface of the second substrate 122 is 20. That is, the first stage 105 includes a total of 20 trays of a tray 140a to a tray 140t to process 20 first substrates 121 of a first substrate 121a to a first substrate 121t corresponding to the trays. Note that in this embodiment, when the function of the tray and the first substrate that correspond to each other is described, the tray and the first substrate are referred to as the tray 140 and the first substrate 121, respectively. In this manner, all of the 20 first substrates 121 are transferred to each part of the first stage 105 by the first transfer means 111.

First, by the third transfer means 115 and the first transfer means 111, the first substrate 121 is transferred from the first cassette chamber 109 through the delivery stage 119 to a predetermined position of the tray 140 of the first stage 105. Here, the front surface of the first substrate 121 transferred to the first stage 105 faces upward. Then, the first substrate 121 is rotated so that the front surface thereof faces downward, and is made to stand by.

As a method other than the method in which the first substrate 121 is transferred by the first transfer means 111 while the front surface thereof faces upward, the first substrate 121 may be transferred to the first stage 105 by the first transfer means 111 while the front surface thereof faces downward. In that case, contaminants attached to the front surface of the first substrate 121 can be reduced.

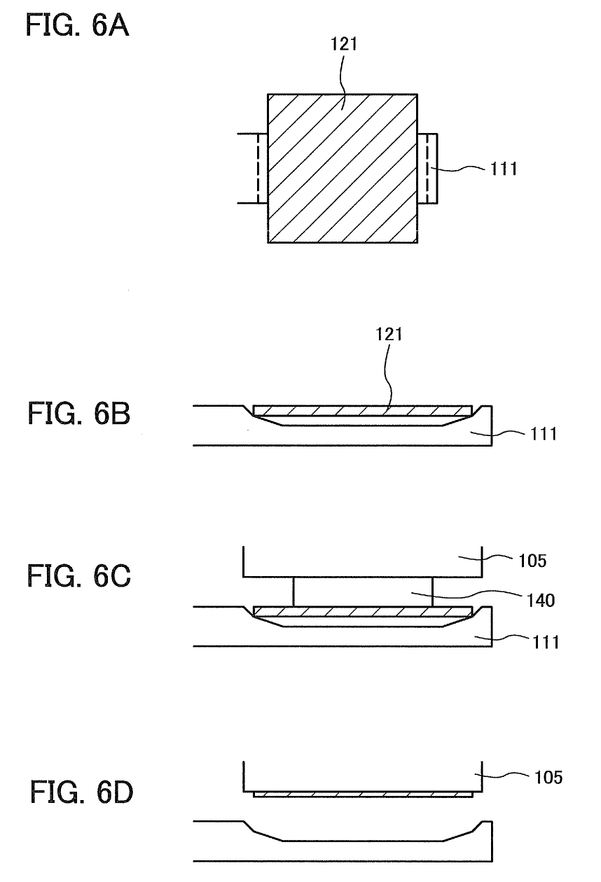

FIG. 6A is a plan view illustrating the first substrate 121 supported by the first transfer means 111. FIG. 6B is a cross-sectional view of FIG. 6A. As illustrated in the drawings, the first transfer means 111 supports the edge of the first substrate 121 and transfers the first substrate 121 to a position just below the tray 140 of the first stage 105 without touching the front surface of the first substrate 121. Then, as illustrated in FIG. 6C, the back surface of the first substrate 121 is adsorbed by the tray 140 of the first stage 105. After that, the tray 140 of the first stage 105 rises as illustrated in FIG. 6D, whereby the first substrate 121 is transferred to the first stage 105.

The aforementioned series of operations are repeated as many times as the number of first substrates 121 bonded to the second substrate 122, so that the first substrates 121 are arranged in all the trays 140 of the first stage 105. At this time, the second substrate 122 is stored in the second cassette chamber 110, and thus is not affected by dust caused by the aforementioned series of operations. In other words, contaminants attached to the substrate surface can be reduced.

Then, the second substrate 122 is transferred onto the second stage 107 that is positioned below the first stage 105. At this time, the position where the substrates are bonded (a relative positional relationship between the second substrate 122 and the first substrate 121) is precisely controlled by a position control mechanism provided on the second stage 107. Note that the precise control may be performed, after the second substrate 122 is arranged, with reference to a marker or the like attached to the second substrate 122. In that case, for example, it is possible to use a method of detecting the position of the marker by using an alignment camera. As the position control mechanism, for example, four linear actuators may be used in combination, whereby the substrates can be precisely controlled in the x direction, the y direction, and the 0 direction.

After the first substrate 121 is arranged, one or both of the first stage 105 and the second stage 107 is operated so that the space (the distance) between the second substrate 122 and the first substrate 121 is reduced as much as possible to the extent that the substrates are not in contact with each other. Then, the first substrate is spaced from the tray 140. Accordingly, the shape of the substrate, which has been changed by being grasped by the tray 140, can be recovered. At this time, the edge of the first substrate 121 is supported by the first stage 105, and thus the first substrate 121 can be prevented from moving in the horizontal direction.

Then, pressure is applied to part of the first substrate 121 by using the pressure-applying mechanism provided in the first stage 105, whereby the first substrate 121 is bonded to the second substrate 122 from the part of the first substrate 121 that is applied with pressure. Specifically, the second substrate 122 and the first substrate 121 are brought into contact with and bonded to each other by the pressure-applying mechanism corresponding to the part of the first substrate 121. The part of the first substrate 121 is the middle of the substrate in this embodiment, although it may be either the middle or the corner of the substrate. By thus starting bonding from a part, the bonding proceeds from a region where the bonding starts to the periphery thereof, and finally, the entire surface of the first substrate 121 is bonded to the second substrate 122. Although not illustrated, it is preferable to provide a mechanism for preventing the second substrate 122 from floating in the bonding. As the mechanism for preventing the second substrate 122 from floating, for example, it is possible to use an electrostatic chuck for pressing the second substrate 122 against the second stage 107.

In order to increase the bonding strength, gradually increasing pressure may be applied to a contact surface. For example, by using a mechanism such as an air cylinder for the first stage 105 including the tray 140, the first substrate 121 may be pressed against the second substrate 122. Since the first stage 105 is raised and lowered using air pressure, pressure can be prevented from being rapidly applied to the contact surface between the second substrate 122 and the first substrate 121, resulting in favorable bonding. Alternatively, a portion the first stage 105, which is in contact with the first substrate 121, may be formed of an elastic body. In that case also, pressure can be prevented from being rapidly applied. Such a pressure-applying mechanism is easily provided for the first stage 105 in designing, and preferably provided in the bonding chamber.

A valve 129 is provided in the bonding chamber 101 so that the cassette chamber is separated from the atmosphere of the bonding chamber 101 when the bonding chamber 101 contains the heat treatment atmosphere. The valve 129 fixed in the bonding chamber 101 is made of a material capable of withstanding the heat treatment. Note that an exhaust means (not illustrated) may be provided so that bonding is performed in a reduced-pressure atmosphere. In that case, effect of contaminants in the atmosphere can be reduced, and thus the bonding surface can be kept clean. In addition, trapping of air in bonding can be reduced.

Next, first heat treatment is performed on the second substrate 122 and the first substrate 121 that are bonded to each other, thereby strengthen the bond. In the case where a heat treatment means is provided in the apparatus, the first heat treatment is performed using the heat treatment means. Even when the heat treatment means is not provided in the apparatus, it is preferable to avoid transferring the second substrate 122 as much as possible and perform the first heat treatment right after the bonding. This is because, if the second substrate 122 is transferred before the first heat treatment and after the bonding, there is an extremely high possibility that the first substrate 121 is separated due to bending of the second substrate 122, or the like. In this embodiment, a case where the first heat treatment is performed using the heat treatment means provided in the apparatus will be described.

The first heat treatment can be performed using heaters provided above the first substrate 121 and below the second substrate 122. This is because, if only one of the bonded substrates is heated, there is a high possibility that a temperature difference occurs between the second substrate 122 and the first substrate 121 and the substrates are bent. On the other hand, when such bending of the substrates is not a problem, the first heat treatment may be performed using one of the heaters provided above the first substrate 121 and below the second substrate 122. The heating temperature needs to be less than or equal to the upper temperature limit of the second substrate 122 and to be a temperature at which a damaged region is not separated. For example, the heating temperature can be 150° C. to 450° C., and preferably 200° C. to 400° C. The first heat treatment may be performed for one minute or more (preferably three minutes or more), although optimal conditions may be determined as appropriate in accordance with the relationship between processing speed and bonding strength. In this embodiment, the first heat treatment is performed at 200° C. for two hours. Note that only parts of the substrates to be bonded may be irradiated with a microwave, whereby the substrates can be locally heated. Note that, when there is no problem with the bonding strength of the substrates, the first heat treatment may be omitted.

After that, the first stage 105 rises and the first substrate 121 is separated from the first stage 105; thus, the bonding of the second substrate 122 and the first substrate 121 is completed.

Through the aforementioned process, bonding is performed by the first heat treatment with the use of the manufacturing apparatus of a composite substrate of the present invention. Then, second heat treatment may be performed at a temperature of 400° C. to 750° C., so that part of the first substrate 121, which is a single crystal silicon layer, is formed over the second substrate 122, namely a base substrate, and the first substrate 121 may be separated from the second substrate 122. At this time, the second heat treatment is performed while the first substrate 121 is prevented from moving on the first stage 105 that is heat resistant enough to withstand the second heat treatment. Accordingly, the first substrate 121 can be prevented from moving on the second substrate 122 after being separated from the second substrate 122, and thus damage on the front surface of the second substrate 122 can be avoided. After that, each first substrate 121 is adsorbed by the tray 140 illustrated in FIG. 3 and can be collected in the first cassette chamber 109 by the first transfer means 111.

Note that the manufacturing apparatus of a composite substrate described in this embodiment can be used in appropriate combination with a manufacturing method of an SOI substrate and a manufacturing method of a semiconductor device, which are described in other embodiments of this specification.

### Embodiment 2

In this embodiment, an example of a manufacturing method of an SOI substrate, which uses the manufacturing apparatus of a composite substrate described in Embodiment 1, will be described with reference to drawings.

First, a plurality of semiconductor substrates corresponding to the first substrates 121 in Embodiment 1 are prepared. In this embodiment, a case of using a total of 20 semiconductor substrates of a semiconductor substrate 200a to a semiconductor substrate 200t will be described.

As the semiconductor substrates 200a to 200t, a commercial single crystal semiconductor substrate can be used. For example, it is possible to use a single crystal silicon substrate, a single crystal germanium substrate, or a compound semiconductor substrate of gallium arsenide, indium phosphide, or the like. A commercial silicon substrate typically has a circular shape with a size of 5 inches (125 mm) in diameter, 6 inches (150 mm) in diameter, 8 inches (200 mm) in diameter, or 12 inches (300 mm) in diameter. Note that the shape of the silicon substrate is not limited to a circular shape, and a silicon substrate processed into a rectangular shape or the like can also be used. Description is made below on the case where the semiconductor substrates 200a to 200t each are a single crystal silicon substrate that is a 5-inch square.

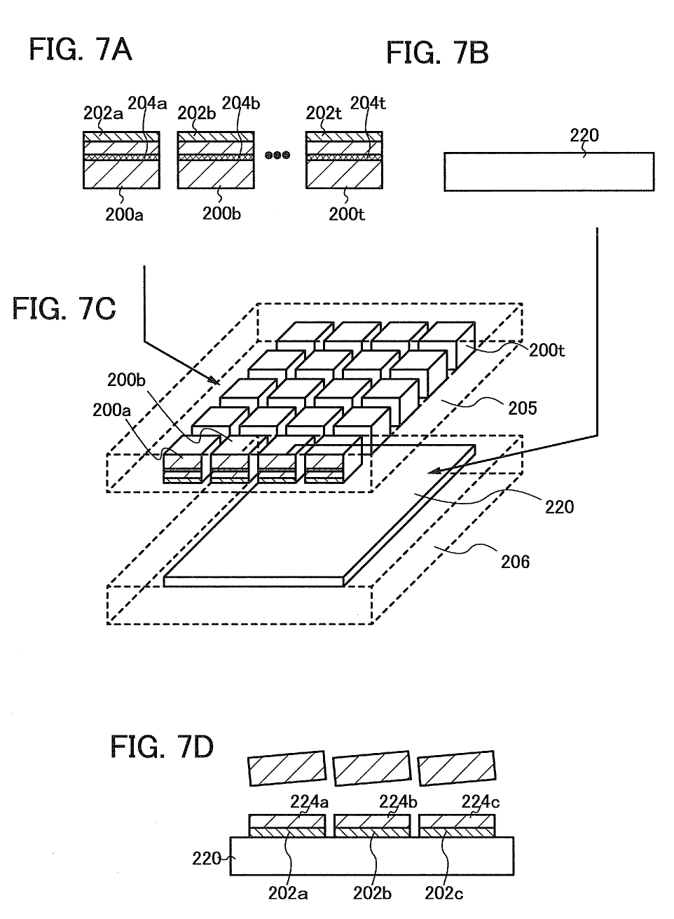

Next, an insulating film 202a is formed on a surface of the semiconductor substrate 200a, and an embrittlement layer 204a is formed at a predetermined depth from the surface of the semiconductor substrate 200a (see FIG. 7A). Similarly, insulating films 202b to 202t are formed over surfaces of the semiconductor substrates 200b to 200t, respectively, and embrittlement layers 204b to 204t are formed at a predetermined depth from the surfaces of the semiconductor substrates 200b to 200t, respectively.

The insulating films 202a to 202t may be, for example, a single layer of a silicon oxide film, a silicon oxynitride film, a silicon nitride film, a silicon nitride oxide film, or the like, or a stacked layer thereof. These films can be formed by thermal oxidization, CVD, sputtering, or the like. In the case where the insulating films 202a to 202t are formed by CVD, a silicon oxide film formed using organosilane such as tetraethoxysilane (abbreviation: TEOS, Si(OC₂H₅)₄) can be used for the insulating films 202a to 202t.

For example, after a silicon oxynitride film and a silicon nitride oxide film are stacked in order over the semiconductor substrates 200a to 200t, ions are introduced into regions at a predetermined depth from the surfaces of the semiconductor substrates 200a to 200t, and then a silicon oxide film formed by CVD using tetraethoxysilane may be formed over the silicon nitride oxide film.

Note that a silicon oxynitride film refers to a film that contains more oxygen than nitrogen and, in the case where measurements are performed using Rutherford backscattering spectrometry (RBS) and hydrogen forward scattering (HFS), includes oxygen, nitrogen, silicon, and hydrogen at concentrations ranging from 50 at. % to 70 at. %, 0.5 at. % to 15 at. %, 25 at. % to 35 at. %, and 0.1 at. % to 10 at. %, respectively. On the other hand, a silicon nitride oxide film refers to a film that contains more nitrogen than oxygen and, in the case where measurements are performed using RBS and HFS, includes oxygen, nitrogen, silicon, and hydrogen at concentrations ranging from 5 at. % to 30 at. %, 20 at. % to 50 at. %, 25 at. % to 35 at. %, and 15 at. % to 25 at. %, respectively. Note that percentages of nitrogen, oxygen, silicon, and hydrogen fall within the ranges given above, where the total number of atoms contained in the silicon oxynitride film or the silicon nitride oxide film is defined as 100 at. %.

Then, the surfaces of the semiconductor substrates 200a to 200t are irradiated with hydrogen ions accelerated by an electric field by an ion doping method or an ion implantation method, whereby the embrittlement layers 204a to 204t are formed at a predetermined depth from the surfaces. The ion implantation method means here that ions are separated by mass, and the ion doping method means that ions are not separated by mass. The ion doping method or the ion implantation method is performed in consideration of the thickness of an SOI layer transferred to a base substrate. The SOI layer has a thickness of 5 nm to 500 nm, preferably 10 nm to 200 nm, more preferably 10 nm to 100 nm, and still more preferably 10 nm to 50 nm. The accelerating voltage for implanting ions to the semiconductor substrates 200a to 200t by the ion doping method or the ion implantation method is determined in consideration of such a thickness. Note that, since the surface of the SOI layer after separation is planarized by being melted or polished by a polishing process such as CMP (chemical mechanical polishing), the SOI layer right after the separation preferably has a thickness of 50 nm to 500 nm.

In the ion doping method for forming the embrittlement layers 204a to 204t, not only H⁺ ions but also either H₃⁺ ions or H₂⁺ ions may be used as main ions. Furthermore, in the ion implantation method, not only H⁺ ions but also H₃⁺ ions or H₂⁺ ions that are hydrogen cluster ions may be implanted. The embrittlement layers 204a to 204t may be formed using rare gas ions as well as hydrogen ions, or a mixture of hydrogen ions and rare gas ions. Before the embrittlement layers 204a to 204t are formed, a native oxide film, a chemical oxide, or an oxide film formed by irradiation with UV light in an oxygen-containing atmosphere is preferably formed over the surfaces of the semiconductor substrates. Here, the chemical oxide can be formed by treatment of the bond wafer surface with an oxidizer such as ozone water, a hydrogen peroxide solution, or sulfuric acid. Alternatively, a thermal oxide film, or a silicon oxide film, a silicon oxynitride film, a silicon nitride oxide film, or the like that is formed by CVD using a silane-based gas may be formed before the embrittlement layers 204a to 204t are formed. The oxide film formed over the surfaces of the semiconductor substrates can prevent the surfaces of the semiconductor substrates from being damaged by etching in forming the embrittlement layers 204a to 204t.

Next, a base substrate 220 corresponding to the second substrate 122 in Embodiment 1 is prepared (see FIG. 7B). Here, description is made on the case where the base substrate 220 is a rectangle of 600 mm×720 mm.

The base substrate 220 is a substrate made of an insulator. Specifically, a glass substrate that is used in the electronics industry, such as an aluminosilicate glass substrate, an aluminoborosilicate glass substrate, or a barium borosilicate glass substrate is used as the base substrate 220. When a glass substrate that can be increased in area and is inexpensive is used as the base substrate 220, the cost can be reduced as compared to the case of using a silicon wafer.

An insulating film may be formed over the surface of the base substrate 220. The insulating film can prevent impurities such as an alkali metal from diffusing from the base substrate 220 and contaminating a semiconductor film. As the insulating film, it is possible to use, as long as sufficient planarity can be obtained, an insulating film containing silicon or germanium obtained by PECVD or sputtering, such as a silicon oxide film, a silicon oxynitride film, a silicon nitride oxide film, a silicon nitride film, a germanium nitride film, a germanium oxynitride film, or a germanium nitride oxide film. Alternatively, it is also possible to use an insulating film containing a metal oxide such as aluminum oxide, tantalum oxide, or hafnium oxide, an insulating film containing a metal nitride such as aluminum nitride, an insulating film containing a metal oxynitride such as aluminum oxynitride, or an insulating film containing a metal nitride oxide such as aluminum nitride oxide. It is needless to say that a film is not necessarily formed over the surface of the base substrate 220, and a structure in which no film is formed over the base substrate 220 is described in this embodiment.

Next, the surfaces of the plurality of semiconductor substrates 200a to 200t are made to face the surface of the base substrate 220, and the insulating films 202a to 202t are bonded to the base substrate 220 (see FIG. 7C). This bonding treatment is performed using the manufacturing apparatus of a composite substrate shown in Embodiment 1. In a manner similar to Embodiment 1, the insulating films 202a to 202t formed on the semiconductor substrates 200a to 200t attached to trays of a first stage 205 are brought close to and bonded to the surface of the base substrate 220 attached to a second stage 206, whereby a bond is formed. This bond is formed under the action of van der Waals forces, and by pressing the semiconductor substrates 200a to 200t against the base substrate 220, a hydrogen bond resulting from Si—OH bonds and the like can be obtained.

Before the semiconductor substrates 200a to 200t are bonded to the base substrate 220, surface treatment is preferably performed on the insulating films 202a to 202t on the semiconductor substrates 200a to 200t and the base substrate 220. As the surface treatment, ozone treatment (e.g., ozone water cleaning) or ultrasonic cleaning can be performed. In that case, one or both of the ozone treatment and the ultrasonic cleaning may be performed. Alternatively, ozone water cleaning and hydrofluoric acid cleaning may be performed more than once. By such surface treatment, dust such as organic substances on the surfaces of the insulating films 202a to 202t and the base substrate 220 can be removed to make the surfaces hydrophilic.

Alternatively, plasma treatment may be performed as the surface treatment. For example, an inert gas (e.g., an Ar gas) and/or a reactive gas (e.g., an O₂ gas or an N₂ gas) are/is introduced into a vacuum chamber and a bias voltage is applied to a surface to be processed (here, the base substrate 220 or the insulating films 202a to 202t), thereby creating a plasma state. Electrons and positive ions of Ar exist in the plasma, and the positive ions of Ar are accelerated in the cathode direction (the side of the surface to be processed). The accelerated positive ions of Ar collide with the surface to be processed so that the surface to be processed is sputter-etched. At this time, a projection on the surface to be processed is preferentially sputter-etched to improve the surface planarity. Such a chamber may be connected to the manufacturing apparatus of a composite substrate of the present invention. By performing such surface treatment, the surfaces of the insulating films 202a to 202t and the base substrate 220 can also be made hydrophilic. In addition, such plasma treatment may be combined with the aforementioned cleaning such as ozone treatment.

Then, heat treatment is performed to separate (cleave) the semiconductor substrates along the embrittlement layers 204a to 204c, whereby single crystal semiconductor films 224a to 224c are obtained over the base substrate 220 with the insulating films 202a to 202c interposed therebetween, respectively (see FIG. 7D). Here, the second heat treatment is performed at a temperature of 400° C. to 750° C. so as to change the volume of microvoids in the embrittlement layers of the semiconductor substrates; thus, the semiconductor substrates can be separated along the embrittlement layers. When the heat treatment apparatus has a structure capable of rapidly heating the base substrate 220 and the semiconductor substrates that are to be processed, the second heat treatment can be performed in a shorter time. In addition, the second heat treatment can be performed at a temperature higher than the strain point of the base substrate 220. The second heat treatment may be performed using a high-temperature gas (gas rapid thermal anneal) or lamp light (lamp rapid thermal anneal).

The second heat treatment can also be performed in the manufacturing apparatus of a composite substrate of the present invention that is shown in Embodiment 1. At this time, the second heat treatment is performed while the first stage 105 is brought into contact with the semiconductor substrates. Thus, after being separated from the base substrate, the semiconductor substrates can be prevented from moving on the base substrate and damaging the surface of the base substrate. After that, each of the semiconductor substrates is adsorbed by the first stage 105 illustrated in FIG. 1, and can be collected in the first cassette chamber 109 by the first transfer means 111.

Through the aforementioned steps, an SOI substrate in which the single crystal semiconductor films 224a to 224c are provided over the base substrate 220 with the insulating films 202a to 202c interposed therebetween, respectively, can be manufactured.

Note that in the aforementioned steps, the surface of the obtained SOI substrate can be subjected to planarization treatment. The planarization treatment makes it possible to planarize the surface of the SOI substrate even when surface roughness occurs on the single crystal semiconductor films 224a to 224c provided over the base substrate 220 after the separation.

The planarization treatment can be performed by CMP (chemical mechanical polishing), etching, laser light irradiation, or the like. Here, the single crystal semiconductor films 224a to 224c are recrystallized and the surfaces thereof are planarized by laser light irradiation after etching treatment (etch-back treatment) of one or both of dry etching and wet etching.

When laser light is emitted from the front surfaces of the single crystal semiconductor films, the front surfaces of the single crystal semiconductor films can be melted. After being melted, the single crystal semiconductor films are cooled and solidified, whereby single crystal semiconductor films each having the front surface with improved planarity can be obtained. With the use of the laser light, the base substrate 220 is not heated directly, which makes it possible to prevent a temperature rise of the base substrate 220. Accordingly, a low-heat resistant substrate such as a glass substrate can be used as the base substrate 220.

Note that it is preferable that the single crystal semiconductor films be partially melted by the laser light irradiation. This is because, if the single crystal semiconductor films are completely melted, it is highly likely to be microcrystallized due to disordered nucleation after being in a liquid phase, leading to a decrease in the crystallinity of the single crystal semiconductor films. On the contrary, by partial melting, crystal growth proceeds from a solid phase part, which is not melted. As a result, defects in the semiconductor films can be reduced. Note that “complete melting” here refers to a state in which the single crystal semiconductor films are melted up to the vicinity of the lower interfaces of the single crystal semiconductor films to be brought into a liquid state. On the other hand, “partial melting” in that case refers to a state in which the upper parts of the single crystal semiconductor films are melted to be brought into a liquid phase whereas the lower parts thereof are kept in a solid phase without being melted.

A pulsed laser is preferably used for the laser light irradiation. This is because a pulsed laser beam having high energy can be emitted instantaneously and a partially melting state can be formed easily. The repetition rate is preferably about 1 Hz to 10 MHz.

After the aforementioned laser light irradiation, a step of reducing the thickness of the single crystal semiconductor films may be performed. The thickness of the single crystal semiconductor films may be reduced by etching treatment (etch-back treatment) of one or both of dry etching and wet etching. For example, in the case where the single crystal semiconductor films are made of a silicon material, the thickness thereof can be reduced by dry etching using SF₆ and O₂ as a process gas.

Note that the planarization treatment may be performed not only on the SOI substrate but also on the semiconductor substrates 200a to 200t after the separation. When the surfaces of the semiconductor substrates 200a to 200t after the separation are planarized, the semiconductor substrates 200a to 200t can be reused in the manufacturing steps of an SOI substrate.

Note that the manufacturing method of an SOI substrate described in this embodiment can be implemented in appropriate combination with the manufacturing methods described in other embodiments of this specification.

### Embodiment 3

In this embodiment, a method for manufacturing a thin film transistor (TFT) using the aforementioned SOI substrate manufactured in Embodiment 2 will be described.

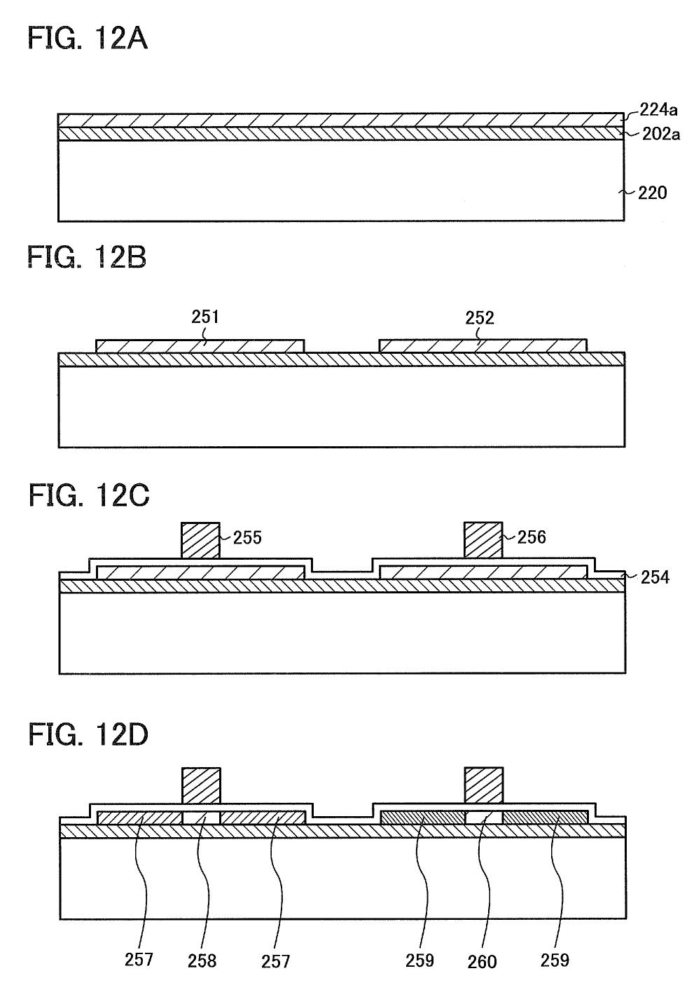

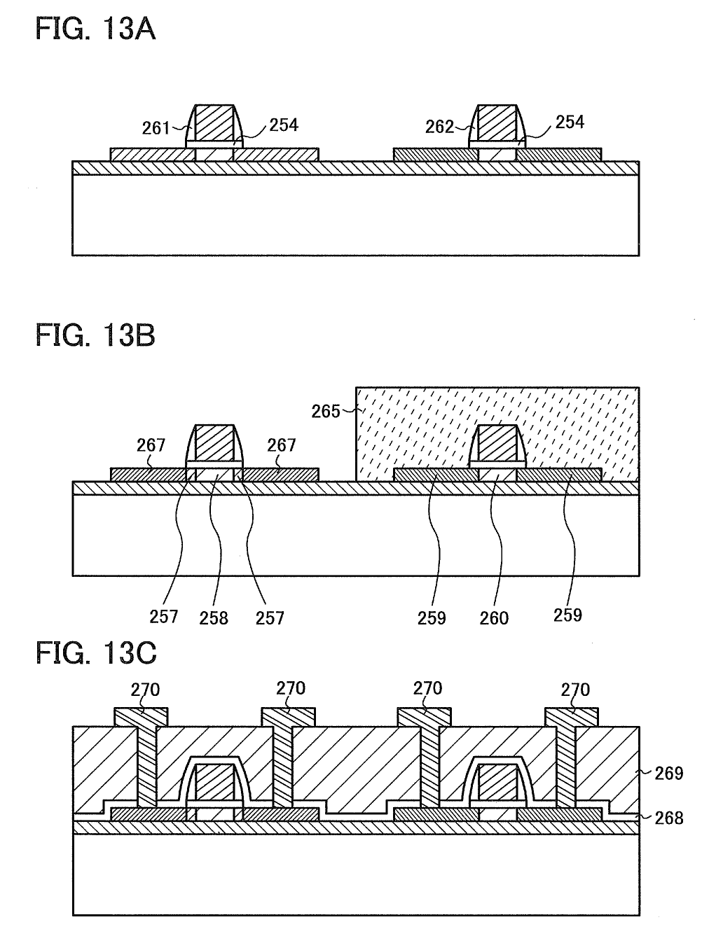

First, a method for manufacturing an n-channel thin film transistor and a p-channel thin film transistor will be described with reference to FIGS. 12A to 12D and FIGS. 13A to 13C. Various kinds of semiconductor devices can be formed by combining a plurality of thin film transistors (TFTs).

Description is made on the case where the SOI substrate manufactured by the method of Embodiment 2 is used as an SOI substrate.

FIG. 12A is a cross-sectional view of the SOI substrate manufactured by the method described with reference to FIG. 3.

The singe crystal semiconductor film 224a is patterned by etching to form semiconductor films 251 and 252 as illustrated in FIG. 12B. The semiconductor film 251 is included in an n-channel TFT, and the semiconductor film 252 is included in a p-channel TFT.

As illustrated in FIG. 12C, an insulating film 254 is formed over the semiconductor films 251 and 252. Then, a gate electrode 255 is formed over the semiconductor film 251 with the insulating film 254 interposed therebetween, and a gate electrode 256 is formed over the semiconductor film 252 with the insulating film 254 interposed therebetween.

Before the single crystal semiconductor film 224a is etched, an impurity element imparting p-type conductivity, such as boron, aluminum, or gallium, or an impurity element imparting n-type conductivity, such as phosphorus or arsenic, is preferably added to the single crystal semiconductor film 224a in order to control the threshold voltage of the TFTs. For example, an impurity element imparting p-type conductivity is added to a region in which an n-channel TFT is to be formed, and an impurity element imparting n-type conductivity is added to a region in which a p-channel TFT is to be formed.

Next, as illustrated in FIG. 12D, n-type low-concentration impurity regions 257 are formed in the semiconductor film 251, and p-type high-concentration impurity regions 259 are formed in the semiconductor film 252. Specifically, first, the n-type low-concentration impurity regions 257 are formed in the semiconductor film 251. In order to form the n-type low-concentration impurity regions 257, the semiconductor film 252 where the p-channel TFT is formed is covered with a resist mask, and an impurity element is added to the semiconductor film 251. As the impurity element, phosphorus or arsenic may be added. By adding the impurity element by an ion doping method or an ion implantation method, the gate electrode 255 functions as a mask, and the n-type low-concentration impurity regions 257 are formed in the semiconductor film 251 in a self-aligned manner. A region of the semiconductor film 251 that overlaps the gate electrode 255 serves as a channel formation region 258.

Next, after the mask that covers the semiconductor film 252 is removed, the semiconductor film 251 where the n-channel TFT is formed is covered with a resist mask. Then, an impurity element is added to the semiconductor film 252 by an ion doping method or an ion implantation method. As the impurity element, boron may be added. In the step of adding the impurity element, the gate electrode 256 functions as a mask and the p-type high-concentration impurity regions 259 are formed in the semiconductor film 252 in a self-aligned manner. The p-type high-concentration impurity regions 259 serve as a source region or a drain region. A region of the semiconductor film 252 that overlaps the gate electrode 256 serves as a channel formation region 260. Here, description is made on the method in which the p-type high-concentration impurity regions 259 are formed after the n-type low-concentration impurity regions 257 are formed; however, the p-type high-concentration impurity regions 259 can be formed first

Next, after the resist that covers the semiconductor film 251 is removed, an insulating film having a single-layer structure or a stacked-layer structure of a nitrogen compound such as silicon nitride or an oxide such as silicon oxide is formed by plasma CVD or the like. This insulating film is anisotropically etched in a perpendicular direction to form sidewall insulating films 261 and 262 that are in contact with side surfaces of the gate electrodes 255 and 256, respectively, as illustrated in FIG. 13A. By this anisotropic etching, the insulating film 254 is also etched.

Next, as illustrated in FIG. 13B, the semiconductor film 252 is covered with a resist 265. In order to form high-concentration impurity regions serving as a source region or a drain region in the semiconductor film 251, an impurity element is added to the semiconductor film 251 at high dose by an ion implantation method or an ion doping method. The gate electrode 255 and the sidewall insulating films 261 function as masks, and n-type high-concentration impurity regions 267 are formed. Then, heat treatment is performed to activate the impurity element.

After the heat treatment for activation, an insulating film 268 containing hydrogen is formed as illustrated in FIG. 13C. After the insulating film 268 is formed, heat treatment is performed at a temperature of 350° C. to 450° C., so as to diffuse hydrogen contained in the insulating film 268 into the semiconductor films 251 and 252. The insulating film 268 can be formed by deposition of silicon nitride or silicon nitride oxide by plasma CVD at a process temperature of 350° C. or less. The supply of hydrogen to the semiconductor films 251 and 252 makes it possible to efficiently correct defects that are to be trapping centers in the semiconductor films 251 and 252 and at an interface with the insulating film 254.

After that, an interlayer insulating film 269 is formed. The interlayer insulating film 269 can have a single-layer structure or a stacked-layer structure of any of films selected from an insulating film containing an inorganic material, such as a silicon oxide film or a BPSG (borophosphosilicate glass) film, and an organic resin film containing polyimide, acrylic, or the like. After contact holes are formed in the interlayer insulating film 269, wirings 270 are formed as illustrated in FIG. 13C. The wirings 270 can be formed of, for example, a conductive film having a three-layer structure in which a low-resistance metal film such as an aluminum film or an aluminum-alloy film is sandwiched between barrier metal films. The barrier metal films can be formed of molybdenum, chromium, titanium, or the like.

Through the aforementioned steps, a semiconductor device having the n-channel TFT and the p-channel TFT can be manufactured. Since the concentration of the metal element contained in the semiconductor film in which the channel formation region is formed is reduced in the manufacturing process of the SOI substrate, a TFT with a low off current and less variations in threshold voltage can be manufactured.

### Embodiment 4

In this embodiment, a method for manufacturing a thin film transistor, which is different from that in the aforementioned embodiment, will be described with reference to drawings. The method for manufacturing a thin film transistor described in this embodiment has a characteristic in that an opening to connect a semiconductor film to a wiring is formed in a self-aligned manner.

First, an SOI substrate manufactured by the method of Embodiment 2 is prepared. Next, a semiconductor film on the SOI substrate is patterned into an island shape to form an island-like semiconductor film 906, and then, an insulating film 908 functioning as a gate insulating film and a conductive film functioning as a gate electrode (or a wiring) are formed in order. In this embodiment, the conductive film functioning as a gate electrode has a two-layer structure; however, the present invention is not limited to this structure. The insulating film 908 can be formed by CVD, sputtering, or the like using a material such as silicon oxide, silicon oxynitride, silicon nitride oxide, or silicon nitride. The thickness of the insulating film 908 may be about 5 nm to 100 nm. The conductive film can be formed by CVD, sputtering, or the like using a material such as tantalum (Ta), tungsten (W), titanium (Ti), molybdenum (Mo), aluminum (Al), copper (Cu), chromium (Cr), or niobium (Nb). The total thickness of the conductive film with two layers may be about 100 nm to 500 nm. Note that in this embodiment, description is made on the case where the insulating film 908 is formed of silicon oxide (with a thickness of 20 nm), and the conductive film (the bottom layer) is formed of tantalum nitride (with a thickness of 50 nm) and the conductive film (the top layer) is formed of tungsten (with a thickness of 200 nm).

Note that, in order to control the threshold voltage of the thin film transistor, an impurity element imparting p-type conductivity, such as boron, aluminum, or gallium, or an impurity element imparting n-type conductivity, such as phosphorus or arsenic, may be added to the semiconductor film. For example, in the case of adding boron as an impurity element imparting p-type conductivity, boron may be added at a concentration of 5×10¹⁶ cm⁻³ to 1×10¹⁷ cm⁻³. In addition, hydrogenation treatment may be performed on the semiconductor film. The hydrogenation treatment is performed, for example, at 350° C. in a hydrogen atmosphere for approximately two hours.

Next, the conductive film functioning as a gate electrode is patterned. Note that, in the method for manufacturing a thin film transistor in this embodiment, patterning is performed on the conductive film more than twice, and the first patterning is performed here. As a result, conductive films 910 and conductive films 912, which are larger than the gate electrodes that are to be formed finally, are formed. Ilere, the word “larger” means a size with which a resist mask for forming the gate electrodes in the second patterning can be formed in accordance with the position of the conductive films 910 and 912. Note that the first patterning and the second patterning may be performed on a region of the conductive film that overlaps the island-like semiconductor film 906 and do not need to be performed on the entire surface of the conductive film.

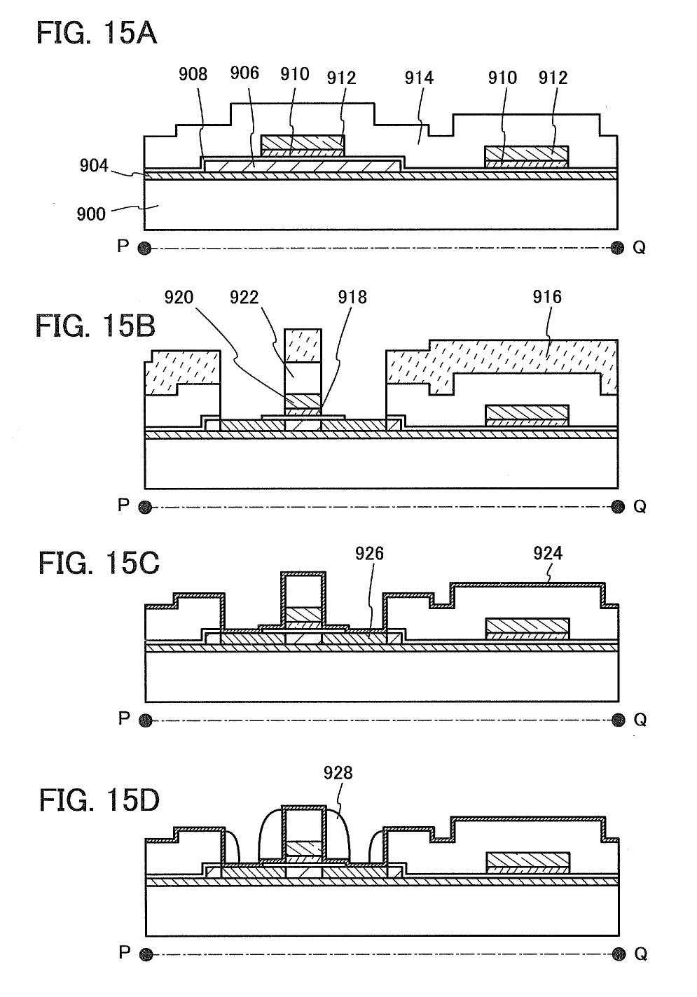

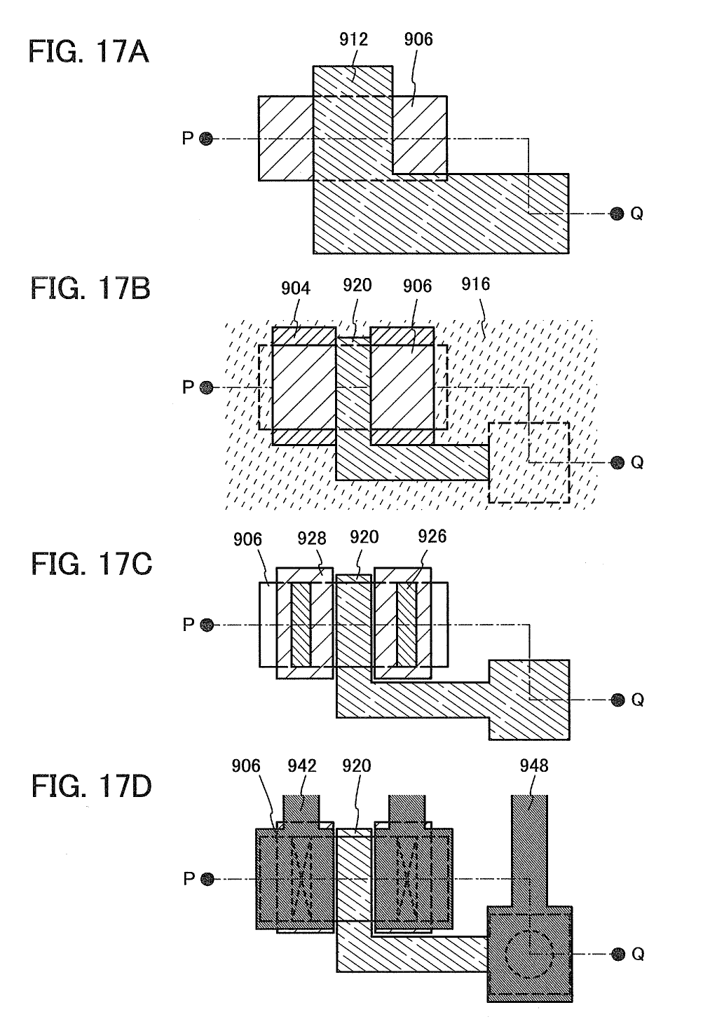

After that, an insulating film 914 is formed to cover the insulating film 908, the conductive films 910 and the conductive films 912 (see FIG. 15A and FIG. 17A). The insulating film 914 can be formed by CVD, sputtering, or the like using a material such as silicon oxide, silicon oxynitride, silicon nitride oxide, silicon nitride, hafnium oxide, or aluminum oxide. The thickness of the insulating film 914 is preferably about 0.5 μm to 2 μm. In this embodiment, description is made on the case where the insulating film 914 is formed of silicon oxide (with a thickness of 1 μm). Note that in this embodiment, the description is made using an SOI substrate having a structure in which an insulating film 904 and a semiconductor film are formed in this order over a base substrate 900; however, the present invention is not construed as being limited thereto.

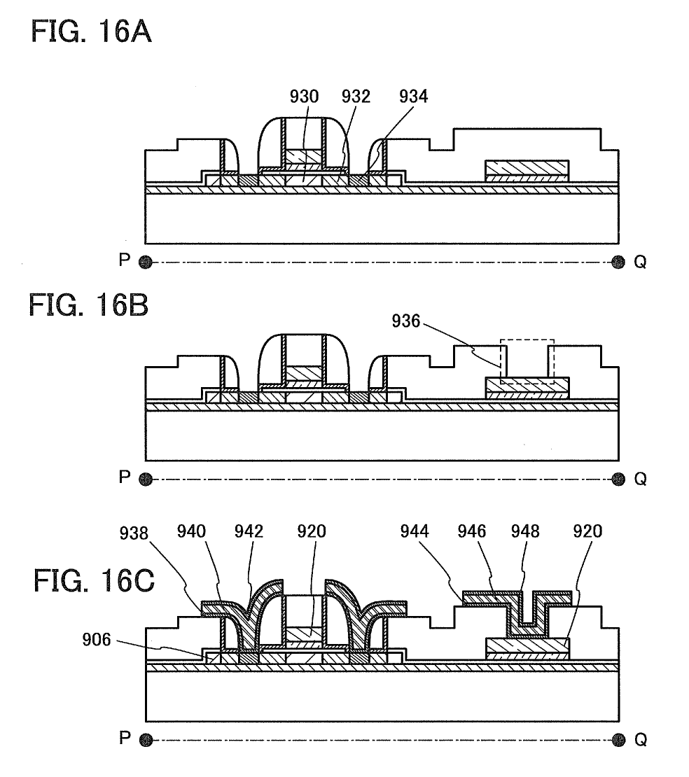

Note that FIG. 15A is a diagram corresponding to a cross section taken along line P-Q of FIG. 17A that is a plane view. Similarly, FIG. 15B, FIG. 15D and FIG. 16C are diagrams corresponding to cross sections taken along lines P-Q of FIG. 17B, FIG. 17C and FIG. 17D, respectively. In the plane views illustrated in FIGS. 17A to 17D, some components in the corresponding cross-sectional views are omitted for simplicity.

Next, a resist mask 916 for forming a gate electrode, which is used in patterning, is formed over the insulating film 914. This patterning corresponds to the second patterning of the first patterning and the second patterning that are performed on the conductive film. The resist mask 916 can be formed by applying a resist material that is a photosensitive substance and then exposing a pattern to light. After formation of the resist mask 916, the conductive film 910, the conductive film 912 and the insulating film 914 are patterned with the use of the resist mask 916. Specifically, the insulating film 914 is selectively etched to form an insulating film 922, and then the conductive film 910 and the conductive film 912 are selectively etched to form a conductive film 918 and a conductive film 920 that serve as a gate electrode (see FIG. 15B and FIG. 17B). Here, when the insulating film 914 is selectively etched, part of the insulating film 908 that serves as a gate insulating film is also etched at the same time as illustrated in FIG. 15B.

Next, after the resist mask 916 is removed, an insulating film 924 is formed to cover the island-like semiconductor film 906, the insulating film 908, the conductive film 918, the conductive film 920, the insulating film 922, and the like. The insulating film 924 serves as a barrier layer when sidewalls are formed later. The insulating film 924 can be formed of a material such as silicon oxide, silicon oxynitride, silicon nitride oxide, silicon nitride, hafnium oxide, aluminum oxide, or tantalum oxide; however, in order to serve as a barrier layer, the insulating film 924 is preferably formed of a material having etching selectivity to a material used for the sidewalls formed later. The thickness of the insulating film 924 may be about 10 nm to 200 nm. In this embodiment, the insulating film 924 is formed of silicon nitride (with a thickness of 50 nm).

After formation of the insulating film 924, an impurity element imparting one conductivity type is added to the island-like semiconductor film 906 using the conductive filn 918, the conductive film 920, the insulating film 922, and the like as masks. In this embodiment, an impurity element imparting n-type conductivity (e.g., phosphorus or arsenic) is added to the island-like semiconductor film 906. By addition of the impurity element, impurity regions 926 are formed in the island-like semiconductor film 906 (see FIG. 15C). Note that in this embodiment, after formation of the insulating film 924, an impurity element imparting n-type conductivity is added; however, the present invention is not limited to this structure. For example, the impurity element may be added after or before the resist mask is removed, and then the insulating film 924 may be formed. Alternatively, an impurity element imparting p-type conductivity may be added.

Next, sidewalls 928 are formed (see FIG. 15D and FIG. 17C). The sidewalls 928 can be formed in such a manner that an insulating film is formed so as to cover the insulating film 924 and anisotropic etching mainly in a perpendicular direction is performed on the insulating film. This is because the insulating film is selectively etched by the anisotropic etching. The insulating film can be formed by CVD, sputtering, or the like using a material such as silicon oxide, silicon oxynitride, silicon nitride oxide, silicon nitride, hafnium oxide, aluminum oxide, or tantalum oxide. Alternatively, a film containing an organic material may be formed by spin coating or the like. In this embodiment, silicon oxide is used as a material for the insulating film. That is, the sidewalls 928 are formed of silicon oxide. In addition, as an etching gas, for example, a mixed gas of CHF₃ and helium can be used. Note that the process of forming the sidewalls 928 is not limited thereto.

Next, an impurity element imparting one conductivity type is added to the island-like semiconductor film 906 using the insulating film 922, the sidewalls 928, and the like as masks. Note that the impurity element that is added to the island-like semiconductor film 906 has the same conductivity type as the impurity element that has been added in the previous step, and has a higher concentration than that of the impurity element that has been added in the previous step. That is, in this embodiment, an impurity element imparting n-type conductivity is added.

By addition of the aforementioned impurity element, a channel formation region 930, low-concentration impurity regions 932, and high-concentration impurity regions 934 are formed in the island-like semiconductor film 906. The low-concentration impurity regions 932 serve as an LDD (lightly doped drain) region and the high-concentration impurity regions 934 serve as a source or a drain.

Next, the insulating film 924 is etched to form openings (contact holes) that reach the high-concentration impurity regions (see FIG. 16A). Since the insulating film 922 and the sidewalls 928 are formed of silicon oxide and the insulating film 924 is formed of silicon nitride in this embodiment, the openings can be formed by selectively etching the insulating film 924.

After formation of the openings that reach the high-concentration impurity regions, the insulating film 914 is selectively etched to form an opening 936 (see FIG. 16B). The opening 936 is formed larger than the openings that reach the high-concentration impurity regions. This is because a minimum line width of the opening 936 is determined in accordance with a process rule or a design rule, while the openings that reach the high-concentration impurity regions are formed in a self-aligned manner to be more miniaturized.

After that, a conductive film is formed so as to be in contact with the high-concentration impurity regions 934 in the island-like semiconductor film 906 and the conductive film 920 through the openings that reach the high-concentration impurity regions and the opening 936. The conductive film can be formed by CVD, sputtering, or the like. As a material of the conductive film, aluminum (Al), tungsten (W), titanium (Ti), tantalum (Ta), molybdenum (Mo), nickel (Ni), platinum (Pt), copper (Cu), gold (Au), silver (Ag), manganese (Mn), neodymium (Nd), carbon (C), silicon (Si), or the like can be used. Moreover, an alloy containing the aforementioned metal as the main component or a compound containing the aforementioned metal may be used. The conductive film may have a single-layer structure or a stacked-layer structure. In this embodiment, description is made on the case where the conductive film has a three-layer structure of titanium, aluminum and titanium.

The aforementioned conductive film is selectively etched to form conductive films 938, conductive films 940 and conductive films 942 that serve as a source or drain electrode (a source or drain wiring), a conductive film 944, a conductive film 946 and a conductive film 948 that are connected to the conductive film 920 and serve as a wiring (see FIG. 16C and FIG. 17D). Through the above steps, a thin film transistor is completed in which a connection between the island-like semiconductor film 906 and the conductive film serving as the source or drain electrode is formed in a self-aligned manner.

Since the connection relationship of the source or drain electrode can be formed in a self-aligned manner by the method described in this embodiment, the transistor can have a miniaturized structure. In other words, the degree of integration of semiconductor elements can be increased. Furthermore, since the length of the channel and the low-concentration impurity region can be determined in a self-aligned manner, variations in channel resistance, which become a problem in miniaturization, can be suppressed. That is, a transistor with excellent characteristics can be provided.

### Embodiment 5

In this embodiment, a specific example of a semiconductor device to which the thin film transistor shown in the above embodiment is applied will be described with reference to drawings.

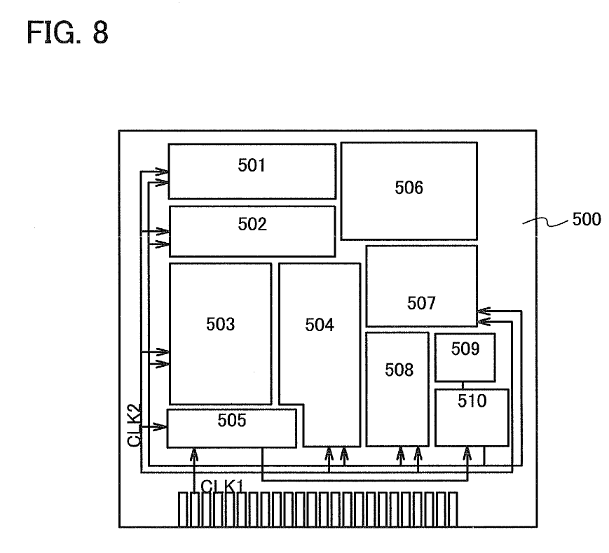

First, as an example of the semiconductor device, a microprocessor is described. FIG. 8 is a block diagram illustrating a structural example of a microprocessor 500.

The microprocessor 500 includes an arithmetic logic unit (ALU) 501, an ALU controller 502, an instruction decoder 503, an interrupt controller 504, a timing controller 505, a register 506, a register controller 507, a bus interface (Bus I/F) 508, a read only memory (ROM) 509, and a memory interface 510.

Instructions input to the microprocessor 500 via the bus interface 508 is input to the instruction decoder 503, decoded therein, and then input to the ALU controller 502, the interrupt controller 504, the register controller 507, and the timing controller 505. The ALU controller 502, the interrupt controller 504, the register controller 507, and the timing controller 505 conduct various controls based on the decoded instructions.

The ALU controller 502 generates signals for controlling the operation of the ALU 501. While the microprocessor 500 is executing a program, the interrupt controller 504 judges and processes an interrupt request from an external input/output device or a peripheral circuit based on its priority or a mask state. The register controller 507 generates an address of the register 506, and reads/writes data from/to the register 506 in accordance with the state of the microprocessor 500. The timing controller 505 generates signals for controlling the timing of operation of the ALU 501, the ALU controller 502, the instruction decoder 503, the interrupt controller 504, and the register controller 507. For example, the timing controller 505 is provided with an internal clock generator for generating an internal clock signal CLK2 based on a reference clock signal CLK1. As illustrated in FIG. 8, the internal clock signal CLK2 is input to other circuits.

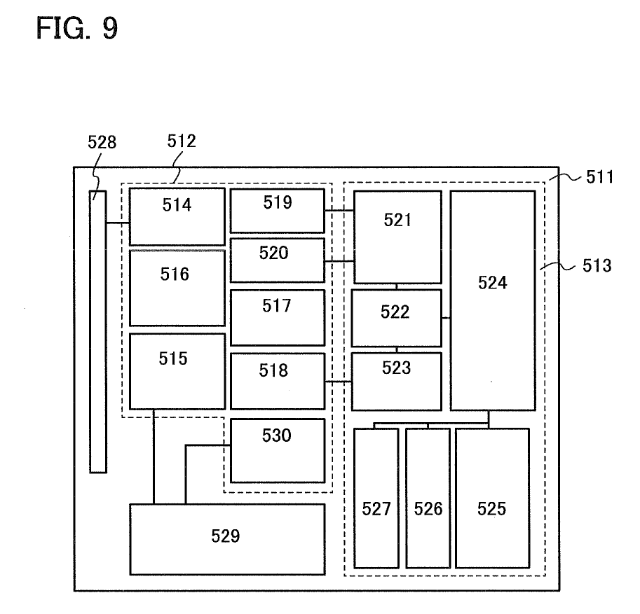

Next, an example of a semiconductor device having an arithmetic function and a function of communicating data wirelessly will be described. FIG. 9 is a block diagram illustrating a structural example of such a semiconductor device. The semiconductor device illustrated in FIG. 9 can be referred to as a computer (hereinafter referred to as an RFCPU) that operates by transmitting/receiving signals to/from an external device by wireless communication.

As illustrated in FIG. 9, an RFCPU 511 includes an analog circuit portion 512 and a digital circuit portion 513. The analog circuit portion 512 includes a resonance circuit 514 having a resonant capacitor, a rectifier circuit 515, a constant voltage circuit 516, a reset circuit 517, an oscillator circuit 518, a demodulation circuit 519, and a modulation circuit 520. The digital circuit portion 513 includes an RF interface 521, a control register 522, a clock controller 523, an interface 524, a central processing unit 525, a random access memory 526, and a read only memory 527.

The operation of the RFCPU 511 is roughly described below. The resonance circuit 514 generates induced electromotive force based on a signal received by an antenna 528. The induced electromotive force is stored in a capacitor portion 529 via the rectifier circuit 515. The capacitor portion 529 preferably includes a capacitor such as a ceramic capacitor or an electric double layer capacitor. The capacitor portion 529 is not necessarily integrated over the same substrate as the RFCPU 511 and may be incorporated into the RFCPU 511 as another component.

The reset circuit 517 generates a signal that resets and initializes the digital circuit portion 513. For example, a signal that rises after an increase in power supply voltage is generated as the reset signal. The oscillator circuit 518 changes the frequency and duty ratio of a clock signal in accordance with a control signal generated by the constant voltage circuit 516. The demodulation circuit 519 demodulates a received signal, and the modulation circuit 520 modulates data to be transmitted.

For example, the demodulation circuit 519 includes a low-pass filter and binarizes a received signal of an amplitude shift keying (ASK) system based on the variation of the amplitude. The modulation circuit 520 transmits data by changing the amplitude of a transmission signal of the amplitude shift keying (ASK) system. Thus, the modulation circuit 520 changes the resonance point of the resonance circuit 514, thereby varying the amplitude of a communication signal.

The clock controller 523 generates a control signal for changing the frequency and duty ratio of the clock signal in accordance with the power supply voltage or the current consumption in the central processing unit 525. The power supply voltage is monitored by the power supply control circuit 530.

A signal that is input to the RFCPU 511 from the antenna 528 is demodulated by the demodulation circuit 519, and then divided into a control command, data, and the like by the RF interface 521. The control command is stored in the control register 522. The control command includes reading of data stored in the read only memory 527, writing of data to the random access memory 526, an arithmetic instruction to the central processing unit 525, and the like.

The central processing unit 525 accesses the read only memory 527, the random access memory 526, and the control register 522 via the interface 524. The interface 524 has a function of generating an access signal to any one of the read only memory 527, the random access memory 526, and the control register 522 based on an address requested by the central processing unit 525.

As an arithmetic method of the central processing unit 525, a method may be employed in which an OS (operating system) is stored in the read only memory 527 and a program is read and executed at the time of starting operation. Alternatively, a method may also be employed in which a circuit dedicated to arithmetic is formed and an arithmetic process is conducted using hardware. In a method using both hardware and software, part of arithmetic process can be conducted by a circuit dedicated to arithmetic, and the other part of the arithmetic process can be conducted by the central processing unit 525 using a program.

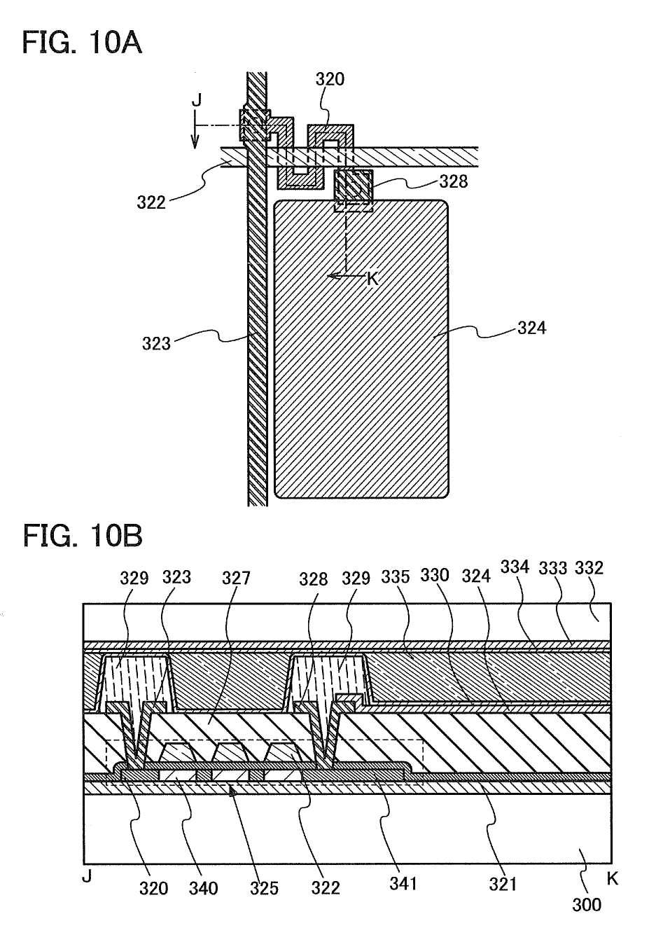

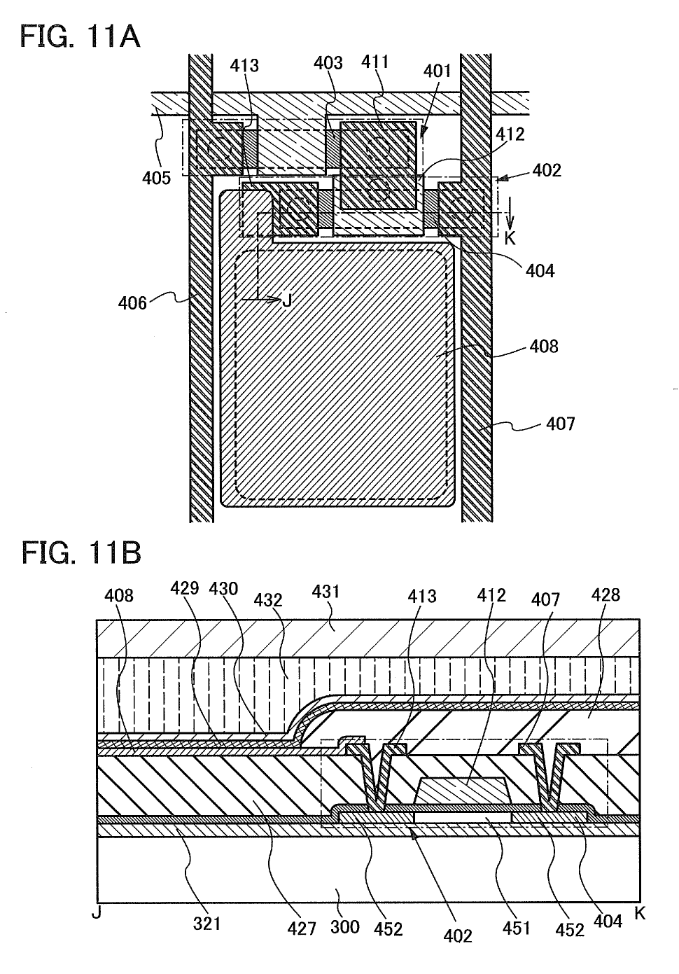

Next, a display device will be described with reference to FIGS. 10A and 10B, and FIGS. 11A and 11B.

FIGS. 10A and 10B are drawings for describing a liquid crystal display device. FIG. 10A is a plan view of a pixel of the liquid crystal display device, and FIG. 10B is a cross-sectional view taken along line J-K of FIG. 10A.

As illustrated in FIG. 10A, a pixel includes a single crystal semiconductor film 320, a scanning line 322 intersecting with the single crystal semiconductor film 320, a signal line 323 intersecting with the scanning line 322, a pixel electrode 324, and an electrode 328 that electrically connects the pixel electrode 324 to the single crystal semiconductor film 320. The single crystal semiconductor film 320 is a layer formed using a single crystal semiconductor film provided over a base substrate 300 and is included in a TFT 325 of the pixel.

As an SOI substrate, the SOI substrate described in the above embodiments is used. As illustrated in FIG. 10B, the single crystal semiconductor film 320 is stacked over the base substrate 300 with an insulating film 321 interposed therebetween. A glass substrate can be used as the base substrate 300. The single crystal semiconductor film 320 of the TFT 325 is a film that is obtained by etching a single crystal semiconductor film of the SOI substrate. A channel formation region 340 and n-type high-concentration impurity regions 341 to which an impurity element is added are formed in the single crystal semiconductor film 320. A gate electrode of the TFT 325 is included in the scanning line 322 and one of a source electrode and a drain electrode of the TFT 325 is included in the signal line 323.

The signal line 323, the pixel electrode 324, and the electrode 328 are provided over an interlayer insulating film 327. Columnar spacers 329 are formed over the interlayer insulating film 327. An orientation film 330 is formed to cover the signal line 323, the pixel electrode 324, the electrode 328, and the columnar spacers 329. A counter substrate 332 is provided with a counter electrode 333 and an orientation film 334 that covers the counter electrode 333. The columnar spacers 329 are formed to maintain the space between the base substrate 300 and the counter substrate 332. A liquid crystal layer 335 is formed in the space formed by the columnar spacers 329. At connection portions of the signal line 323 and the electrode 328 with the high-concentration impurity regions 341, there are steps formed in the interlayer insulating film 327 due to formation of contact holes; thus, liquid crystal orientation in the liquid crystal layer 335 at these connection portions is likely to be disordered. Therefore, the columnar spacers 329 are formed at these steps to prevent the liquid crystal orientation from being disordered.

Next, an electroluminescence display device (hereinafter referred to as an EL display device) will be described with reference to FIGS. 11A and 11B. FIG. 11A is a plan view of a pixel of the EL display device, and FIG. 11B is a cross-sectional view taken along line J-K of FIG. 11A.

As illustrated in FIG. 11A, a pixel includes a TFT as a selection transistor 401, a TFT as a display control transistor 402, a scanning line 405, a signal line 406, a current supply line 407, and a pixel electrode 408. In the EL display device, each pixel is provided with a light-emitting element having a structure in which a layer containing an electroluminescent material (an EL layer) is sandwiched between a pair of electrodes. One electrode of the light-emitting element is the pixel electrode 408. Furthermore, a semiconductor film 403 includes a channel formation region, a source region, and a drain region of the selection transistor 401. A semiconductor film 404 includes a channel formation region, a source region, and a drain region of the display control transistor 402. The semiconductor films 403 and 404 are layers that are formed using a single crystal semiconductor film provided over the base substrate.

In the selection transistor 401, a gate electrode is included in the scanning line 405, one of a source electrode and a drain electrode is included in the signal line 406, and the other thereof is formed as an electrode 411. In the display control transistor 402, a gate electrode 412 is electrically connected to the electrode 411, one of a source electrode and a drain electrode is formed as an electrode 413 that is electrically connected to the pixel electrode 408, and the other thereof is included in the current supply line 407.

The display control transistor 402 is a p-channel TFT. As illustrated in FIG. 11B, a channel formation region 451 and p-type high-concentration impurity regions 452 are formed in the semiconductor film 404. Note that as the SOI substrate, the SOI substrate manufactured in the aforementioned embodiment is used.

An interlayer insulating film 427 is formed to cover the gate electrode 412 of the display control transistor 402. The signal line 406, the current supply line 407, the electrode 411, the electrode 413, and the like are formed over the interlayer insulating film 427. The pixel electrode 408 that is electrically connected to the electrode 413 is formed over the interlayer insulating film 427. A peripheral portion of the pixel electrode 408 is surrounded by a partition wall layer 428 having an insulating property. The EL layer 429 is formed over the pixel electrode 408, and a counter electrode 430 is formed over the EL layer 429. A counter substrate 431 is provided as a reinforcing plate and fixed to the base substrate 300 by a resin layer 432.

The gray scale of the EL display device can be controlled by a current driving method in which the luminance of a light-emitting element is controlled by current or a voltage driving method in which the luminance of a light-emitting element is controlled by voltage. In the case where the transistors of each pixel have largely different characteristic values, it is difficult to employ the current driving method; in order to employ the current driving method in such a case, a correction circuit for correcting characteristic variations is needed. The EL display device is manufactured by a manufacturing method including manufacturing steps of an SOI substrate and a gettering step, whereby the selection transistor 401 and the display control transistor 402 do not have variations in characteristics in each pixel. Thus, the current driving method can be employed.

That is, a variety of electronic devices can be manufactured using the SOI substrate. The electronic devices include, in its category, cameras such as video cameras and digital cameras, navigation systems, audio reproducing devices (such as car audio sets and audio components), computers, game machines, portable information terminals (such as mobile computers, cellular phones, portable game machines, and e-book readers), and image reproducing devices having recording media (specifically, devices provided with display devices capable of playing audio data stored in recording media such as a digital versatile disk (DVD) and displaying stored image data).

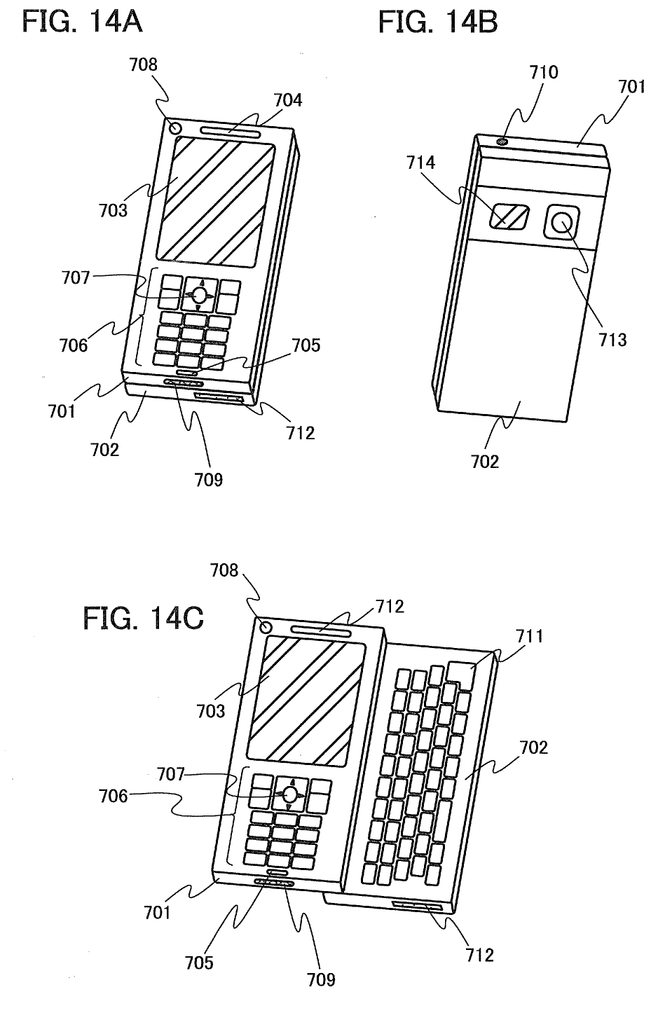

FIGS. 14A to 14C illustrate an example of a cellular phone to which the present invention is applied. FIG. 14A is a front view, FIG. 14B is a rear view, and FIG. 14C is a front view in which two housings are slid. The cellular phone includes two housings: a housing 701 and a housing 702. The cellular phone is a so-called smartphone that has both functions of a cellular phone and a portable information terminal and incorporates a computer, and thus is capable of a variety of data processing in addition to voice calls.

The cellular phone includes the housing 701 and the housing 702. The housing 701 includes a display portion 703, a speaker 704, a microphone 705, operation keys 706, a pointing device 707, a front camera lens 708, a jack 709 for an external connection terminal, an earphone terminal 710, and the like. The housing 702 includes a keyboard 711, an external memory slot 712, a rear camera 713, a light 714, and the like. In addition, an antenna is incorporated in the housing 701.

Furthermore, in addition to the above structure, a wireless IC chip, a small memory device, or the like may be incorporated in the cellular phone.

The housings 701 and 702 that overlap each other (see FIG. 14A) can be slid, and are developed by being slid as illustrated in FIG. 14C. The display panel or the display device that is manufactured by the methods for manufacturing a display device described in Embodiments 2 and 3 can be incorporated in the display portion 703. Since the front camera lens 708 is provided in the same plane as the display portion 703, the cellular phone can be used as a videophone. Furthermore, by using the display portion 703 as a viewfinder, still images and moving images can be taken with the rear camera 713 and the light 714.

By using the speaker 704 and the microphone 705, the cellular phone can be used as an audio recording device (recording device) or an audio reproducing device. In addition, with the use of the operation keys 706, it is possible to perform operations of incoming and outgoing of calls, simple information input such as e-mails, scrolling of a screen to be displayed on the display portion, cursor movement, e.g., for selecting information to be displayed on the display portion, and the like.

If much information needs to be treated in documentation, the use as a portable information terminal, and the like, it is convenient to use the keyboard 711. By sliding the housings 701 and 702 that overlap each other (FIG. 14A), the housings 701 and 702 can be developed as illustrated in FIG. 14C. In using the cellular phone as a portable information terminal, a cursor can be moved smoothly with the use of the keyboard 711 and the pointing device 707. The jack 709 for an external connection terminal can be connected to an AC adapter or a variety of cables such as a USB cable, thereby performing charging and data communication with a personal computer or the like. Furthermore, by inserting a recording medium into the external memory slot 712, a larger amount of data can be stored and moved.

The rear face of the housing 702 (FIG. 14B) is provided with the rear camera 713 and the light 714, and still images and moving images can be taken using the display portion 703 as a viewfinder.

Furthermore, in addition to the above functions and structures, the cellular phone may have an infrared communication function, a USB port, a function of receiving one segment television broadcast, a wireless IC chip, an earphone jack, or the like.

The variety of electronic devices described in this embodiment can be manufactured by any of the aforementioned methods for manufacturing a thin film transistor and a display device; therefore, display characteristics and productivity of these electronic devices can be improved by applying the present invention.

This application is based on Japanese Patent Application serial No. 2008-058222 filed with Japan Patent Office on Mar. 7, 2008, the entire contents of which are hereby incorporated by reference.

What is claimed is:

1. A manufacturing apparatus of a composite substrate, which comprises a plurality of first substrates being bonded to a second substrate, comprising:
a plurality of trays each for holding and fixing back surfaces of the plurality of first substrates;
a first stage, which includes and holds the plurality of trays so that front surfaces of the plurality of first substrates face vertically downward;
a second stage opposite to the first stage, which holds and fixes the second substrate so that a front surface of the second substrate faces vertically upward;
a stage driving portion for moving the first stage and the second stage so that the plurality of first substrates and the second substrate are brought close to each other; and
a pressure-applying mechanism for applying pressure to parts of the back surfaces of the plurality of first substrates while the first substrates and the second substrate are close to each other.

2. The manufacturing apparatus of the composite substrate, according to claim 1, wherein the pressure-applying mechanism is provided over the first stage.

3. The manufacturing apparatus of the composite substrate, according to claim 1, comprising a first transfer means and a second transfer means,
wherein the first transfer means has a means for transferring the plurality of first substrates to the tray; and
wherein the second transfer means has a means for transferring the second substrate to the second stage.

4. The manufacturing apparatus of the composite substrate, according to claim 1, wherein the tray has a rotating means by which the plurality of first substrates supported with the front surfaces facing vertically upward are rotated so that the front surfaces thereof face vertically downward and supported.

5. The manufacturing apparatus of the composite substrate, according to claim 1, comprising a heat treatment means,
wherein the heat treatment means has a means for performing heat treatment on the plurality of first substrates and the second substrate.

6. The manufacturing apparatus of the composite substrate, according to claim 5, wherein the heat treatment means uses convection heating with gas.

7. The manufacturing apparatus of the composite substrate, according to claim 5, wherein the heat treatment means uses radiation from an element heated with Joule heat.

8. The manufacturing apparatus of the composite substrate, according to claim 1, comprising a means for cleaning one or both of the front surfaces of the plurality of first substrates and the front surface of the second substrate.

9. A manufacturing apparatus of a composite substrate, which comprises a plurality of first substrates being bonded to a second substrate, comprising:
a plurality of trays each for holding and fixing back surfaces of the plurality of first substrates;
a first stage, which includes and holds the plurality of trays so that front surfaces of the plurality of first substrates face vertically downward;
a second stage opposite to the first stage, which holds and fixes the second substrate so that a front surface of the second substrate faces vertically upward;
a stage driving portion for moving the first stage and the second stage so that the plurality of first substrates and the second substrate are brought close to each other;
a pressure-applying mechanism for applying pressure to parts of the back surfaces of the plurality of first substrates while the first substrates and the second substrate are close to each other; and
a heat treatment means for performing heat treatment on the plurality of first substrates and the second substrate, the heat treatment means comprising a heating gas supply unit, a temperature sensor, and a temperature control unit,
wherein the heating gas supply unit is controlled by the temperature sensor and the temperature control unit.

10. The manufacturing apparatus of the composite substrate, according to claim 9, wherein the pressure-applying mechanism is provided over the first stage.

11. The manufacturing apparatus of the composite substrate, according to claim 9, comprising a first transfer means and a second transfer means,
wherein the first transfer means has a means for transferring the plurality of first substrates to the tray; and
wherein the second transfer means has a means for transferring the second substrate to the second stage.

12. The manufacturing apparatus of the composite substrate, according to claim 9, wherein the tray has a rotating means by which the plurality of first substrates supported with the front surfaces facing vertically upward are rotated so that the front surfaces thereof face vertically downward and supported.

13. The manufacturing apparatus of the composite substrate, according to claim 9, comprising a means for cleaning one or both of the front surfaces of the plurality of first substrates and the front surface of the second substrate.

14. A manufacturing method of a composite substrate, which comprises a plurality of first substrates being bonded to a second substrate, comprising the steps of:
arranging the plurality of first substrates on corresponding trays so that front surfaces of the plurality of first substrates face vertically downward;
arranging the second substrate on a second stage so that a front surface of the second substrate faces vertically upward; and
spacing the plurality of first substrates from the trays and applying pressure to parts of the plurality of first substrates while edges of the plurality of first substrates are supported, whereby the front surfaces of the plurality of first substrates are bonded to the front surface of the second substrate.

15. The manufacturing method of the composite substrate, according to claim 14,
wherein the trays are rotated after the plurality of first substrates are arranged on the corresponding trays so that the front surfaces of the plurality of first substrates face vertically upward; and
wherein the plurality of first substrates are arranged on the corresponding trays so that the front surfaces of the plurality of first substrates face vertically downward.

16. The manufacturing method of the composite substrate, according to claim 14, wherein heat treatment is performed on the plurality of first substrates and the second substrate after the front surfaces of the plurality of first substrates are bonded to the front surface of the second substrate.

17. The manufacturing method of the composite substrate, according to claim 16, wherein the heat treatment is performed at a temperature of 150° C. to 450° C.

18. The manufacturing method of the composite substrate, according to claim 17: wherein after the heat treatment is performed on the plurality of first substrates and the second substrate, heat treatment is performed at a temperature of 400° C. to 750° C. while the edges of the plurality of first substrates are supported; and
wherein the plurality of first substrates are spaced from the second substrate while being supported by the trays.

19. The manufacturing method of the composite substrate, according to of claim 14, wherein one or both of the front surfaces of the plurality of first substrates and the front surface of the second substrate is or are cleaned before the plurality of first substrates are bonded to the second substrate.
